(19) United States
(12) Patent Application Publication
(10) Pub. No.: US 2025/0217743 A1
(43) Pub. Date: Jul. 3, 2025

(54) MULTI-SERVICE BUSINESS PLATFORM SYSTEM HAVING CUSTOM WORKFLOW ACTIONS SYSTEMS AND METHODS

(71) Applicant: HUBSPOT, INC., Cambridge, MA (US)

(72) Inventors: Jesse TREMBLAY, Cambridge, MA (US); John RUSSELL, Acton, MA (US)

(21) Appl. No.: 19/087,715

(22) Filed: Mar. 24, 2025

Related U.S. Application Data
(63) Continuation of application No. 17/660,085, filed on Apr. 21, 2022, now Pat. No. 12,271,847.
(60) Provisional application No. 63/201,274, filed on Apr. 21, 2021.

(51) Int. Cl. G06Q 10/0631; G06F 3/0482; G06Q 10/0633

(52) U.S. Cl. CPC G06Q 10/06316; G06F 3/0482; G06Q 10/0633

(57) ABSTRACT

The disclosure is directed to various ways of improving the functioning of computer systems, information networks, data stores, search engine systems and methods, and other advantages. Among other things, provided herein are methods, systems, components, processes, modules, blocks, circuits, sub-systems, articles, and other elements (collectively referred to in some cases as the “platform” or the “system”) that collectively enable, in one or more datastores and systems. A system and method (e.g., a custom workflow actions system and related processes) for creating and using a custom action (e.g., custom code action). The custom code action may be created and added to a workflow. The workflow may be executed based on the occurrence of one or more events such that the new custom code action may be triggered as part of the workflow (e.g., resulting in an occurrence of a customized action corresponding with a custom instruction code).

### CROSS-REFERENCE TO RELATED APPLICATIONS

The present application is a continuation of and claims priority to U.S. application Ser. No. 17/660,085, filed Apr. 21, 2022, which claims priority to U.S. Provisional Application Ser. No. 63/201,274, filed Apr. 21, 2021, which are hereby incorporated by reference in its entirety.

### TECHNICAL FIELD

The present application relates to a multi-client service system platform that may be part of a multi-service business platform.

### BACKGROUND

Conventional systems for enabling marketing and sales activities for a business user do not also respectively enable support and service interactions with customers, notwithstanding that the same individuals are typically involved in all of those activities for a business, transitioning in status from prospect, to customer, to user. While marketing activities, sales activities, and service activities strongly influence the success of each other, businesses are required to undertake complex and time-consuming tasks to obtain relevant information for one activity from the others, such as forming queries, using complicated APIs, or otherwise extracting data from separate databases, networks, or other information technology systems (some on premises and others in the cloud), transforming data from one native format to another suitable form for use in a different environment, synchronizing different data sources when changes are made in different databases, normalizing data, cleansing data, and configuring it for use.

Some systems are customer relationship management (CRM) systems that may generally provide ability to manage and analyze interactions with customers for businesses. For example, these CRM systems may compile data from various communication channels (e.g., email, phone, chat, content materials, social media, etc.). For example, some CRM systems can be used to monitor and track CRM standard objects. These CRM standard objects can include typical business objects such as accounts (e.g., accounts of customers), contacts (e.g., persons associated with accounts), leads (e.g., prospective customers), and opportunities (e.g., sales or pending deals).

### SUMMARY

According to some example embodiments of the disclosure, a computer-implemented method for creating and using a custom action is disclosed. The method may include creating a new workflow associated with one or more events. A custom code action may be selected from a list of actions. A new custom code action may be created that is added to the new workflow based on the selection. A custom instruction code may be received for a customized action associated with the new custom code action. The new workflow may be executed based on an occurrence of the one or more events. The new custom code action may be triggered as part of the execution of the new workflow. The triggering of the new custom code action may execute the custom instruction code resulting in the occurrence of the customized action corresponding with the custom instruction code.

In example embodiments, the method may further include a workflow system for controlling, configuring, and executing the new workflow in a platform. The workflow system may utilize an automation application programming interface (API) to provide at least one of a “Get” functionality, a “Post” functionality, a “Put” functionality, or a “Delete” functionality with respect to the new workflow.

In example embodiments, the method may further include defining the new custom code action with at least one input and a web address such that when the new custom code action is triggered, at least one request is sent to the web address with a payload.

In example embodiments, the method may further include defining the new custom code action with workflow-related information for the new workflow, a preferred request format for requests received, an action name, and at least one action input. The defined new custom code action may include at least one input option that defines at least one set of valid values for the at least one action input. The at least one input option is at least one of a static list or a webhook web address.

In example embodiments, the method may further include determining a success of the new custom code action being triggered by examining a status code returned that indicates at least one of: an action completed successfully, an action failed, or a temporary problem with service.

In example embodiments, the one or more events may be defined as a change in a platform such that the platform may provide one or more actions including at least one of configuring or setting properties, sending emails, sending notifications, or calling one or more web addresses based, at least partially, on the change in the platform.

In example embodiments, the new custom code action may include a function that when executed allows for a platform to operate on data that may be associated with the new workflow. The data may relate to enrollment of one or more objects. The one or more objects may include at least one of a core object or a custom object such that object-related data is available for operation when the new workflow is executed.

In example embodiments, the new custom code action may provide at least one of: a process for keeping user data organized by reformatting data or a process for driving other processes.

In example embodiments, the new custom code action may provide at least one of: data cleanup, data formatting and reformatting, advanced lead rotation, service level agreement (SLA) management, verification of customer data inputs based on an external service, or advanced customer onboarding automation.

According to some example embodiments of the disclosure, a computer-implemented method for creating and using a custom action is disclosed. The method may include opening a previously created workflow associated with one or more events. A custom code action may be selected from a list of actions. A new custom code action may be created that may be added to the previously created workflow based on the selection. A custom instruction code may be received for a customized action associated with the new custom code action. The previously created workflow may be executed based on an occurrence of the one or more events. The new custom code action may be triggered as part of the execution of the previously created workflow. The triggering of the new custom code action may execute the custom instruction code resulting in the occurrence of the customized action corresponding with the custom instruction code.

In example embodiments, the method may further include a workflow system for controlling, configuring, and executing the previously created workflow in a platform. The workflow system may utilize an automation application programming interface (API) to provide at least one of a “Get” functionality, a “Post” functionality, a “Put” functionality, or a “Delete” functionality with respect to the previously created workflow.

In example embodiments, the method may further include defining the new custom code action with workflow-related information for the previously created workflow, a preferred request format for requests received, an action name, and at least one action input.

In example embodiments, the method may further include determining a success of the new custom code action being triggered by examining a status code returned that indicates at least one of: an action completed successfully, an action failed, or a temporary problem with service.

In example embodiments, the one or more events may be defined as a change in a platform such that the platform may provide one or more actions including at least one of configuring or setting properties, sending emails, sending notifications, or calling one or more web addresses based, at least partially, on the change in the platform.

In example embodiments, the new custom code action may include a function that when executed allows for a platform to operate on data that may be associated with the previously created workflow. The data may relate to enrollment of one or more objects. The one or more objects may include at least one of a core object or a custom object such that object-related data is available for operation when the previously created workflow is executed.

In example embodiments, the new custom code action may provide at least one of: a process for keeping user data organized by reformatting data, a process for driving other processes, a data cleanup process, data formatting and reformatting processes, an advanced lead rotation process, a service level agreement (SLA) management process, a verification process of customer data inputs based on an external service, or an advanced customer onboarding automation process.

According to some example embodiments of the disclosure, a non-transitory computer readable storage medium is disclosed. The non-transitory computer readable storage medium may include a plurality of instructions stored thereon which, when executed across one or more processors, causes at least a portion of the one or more processors to perform operations including: creating a new workflow or opening a previously created workflow associated with one or more events. A custom code action may be selected from a list of actions. A new custom code action may be created that may be added to the new workflow or the previously created workflow based on the selection. A custom instruction code may be received for a customized action associated with the new custom code action. The new workflow or the previously created workflow may be executed based on an occurrence of the one or more events. The new custom code action may be triggered as part of the execution of the new workflow or the previously created workflow. The triggering of the new custom code action may execute the custom instruction code resulting in the occurrence of the customized action corresponding with the custom instruction code.

In example embodiments, the new custom code action may provide at least one of: a process for keeping user data organized by reformatting data, a process for driving other processes, a data cleanup process, data formatting and reformatting processes, an advanced lead rotation process, a service level agreement (SLA) management process, a verification process of customer data inputs based on an external service, or an advanced customer onboarding automation process.

A more complete understanding of the disclosure will be appreciated from the description and accompanying drawings and the claims, which follow.

These and other systems, methods, objects, features, and advantages of the disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts a high-level flow in which a content platform.

FIG. 2 provides a functional block diagram of a content development platform.

FIGS. 3, 4, and 5 show examples of user interface elements.

FIG. 6 provides a functional block diagram of a content development platform.

FIG. 7 provides a detailed functional block diagram a content development platform.

FIG. 8 illustrates a user interface for reporting information relating to online content generated using the content development and management platform.

FIG. 9 depicts a user interface.

FIG. 10 illustrates an example environment of a directed content system disclosure.

FIG. 11 depicts an example of the crawling system.

FIG. 12 depicts a visual representation of a knowledge graph representation.

FIG. 13 illustrates an example configuration of the lead scoring system.

FIG. 14 illustrates an example configuration of the directed content system.

FIG. 15 illustrates a method for generating personalized messages on behalf of a user.

FIG. 16 illustrates an example environment of a multi-client service system platform.

FIGS. 17A-17C illustrates examples of a database objects.

FIG. 18 depicts a visual representation of an example knowledge graph representation.

FIG. 19 illustrates an example of a multi-client service system platform providing service systems on behalf of two independent clients according to one or more embodiments of the disclosure.

FIG. 20 is a flow chart illustrating a method for deploying a client-specific service system.

FIGS. 21-44 are screenshots showing an example GUI

FIG. 45 is an example environment view of a multi-service business platform.

FIG. 46 is an example detailed view of a customization system.

FIG. 47 is an example detailed view of a custom object and associations.

FIG. 48 depicts a visual representation of an example instance knowledge graph representation.

FIG. 49A is a screenshot of an example graphical user interface (GUI).

FIG. 50 is a flow chart illustrating a set of operations of a method for using the customization system of the multi-service business platform according to one or more embodiments of the disclosure.

FIG. 51 is a block diagram of an example entity resolution system embodiment of entity deduplication methods and systems according to one or more embodiments of the disclosure.

FIG. 52 is a block diagram of an example entity deduplication training process.

FIG. 53 is a flow chart of an example entity deduplication training process.

FIG. 54 is a block and data flow diagram of a training embodiment for entity deduplication.

FIG. 55 is a portion of a system for entity deduplication showing backend functions that facilitate refining a neural network generated probability of entity pairs being duplicates.

FIG. 56 is a flow chart of a first embodiment of artificial intelligence-based deduplication.

FIG. 57 is a diagram of entity feature-vector and companion matrices.

FIG. 58 is a flow chart of an artificial intelligence-based deduplication process.

FIG. 59 is a flow chart of an artificial intelligence-based deduplication.

FIG. 60 is a schematic that depicts an example schema of an event record.

FIG. 61 is a schematic that depicts an example configuration of a reporting system.

FIGS. 62A and 62B are schematics that depict example report request graphical user interfaces.

FIGS. 63A, 63B, and 63C are schematics that depict example report configuration GUIs.

FIG. 64 is a schematic that depicts an example configuration of a payment system aure.

FIG. 65 is a flow chart that depicts a method for generating a checkout link o

FIG. 66 is a flow chart that depicts a method for processing a payment.

FIG. 67 is an example view of the conversation intelligence system.

FIG. 68 is an example detailed view of a conversation object.

FIG. 69 is a flow chart illustrating a set of operations of a method.

FIGS. 70, 71, 72, 73, and 74 are screenshots of example GUIs.

FIG. 75 is a flow chart illustrating a set of operations of a method for using a workflow system and a custom workflow actions system of the multi-service business platform to create a custom code action and execute the custom code action according to one or more embodiments of the disclosure.

FIGS. 76-87C are screenshots of examples of graphical user interfaces (GUIs.

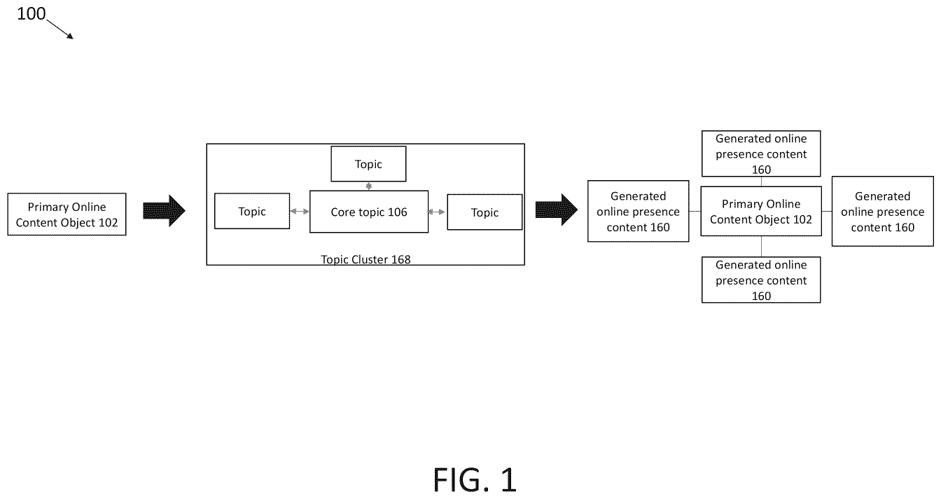

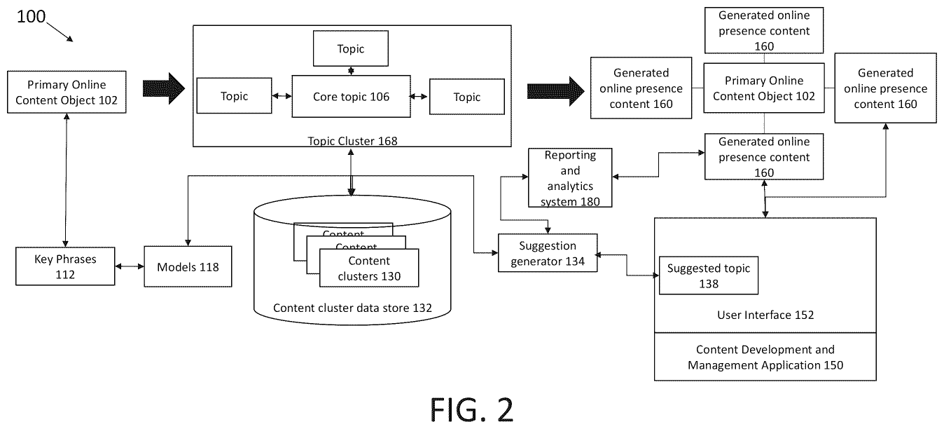

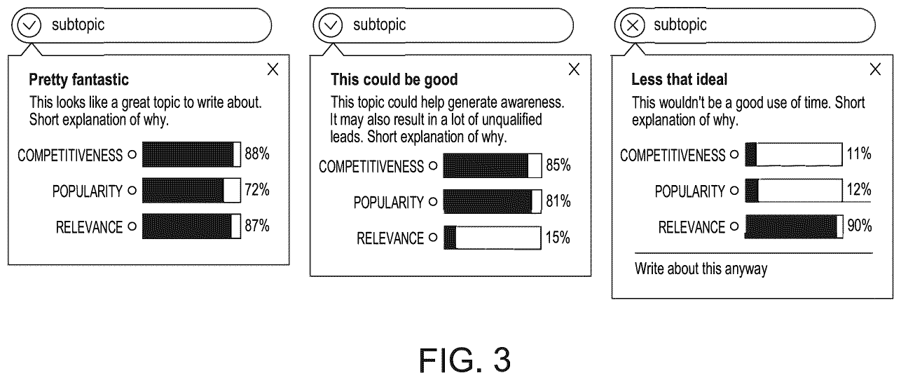

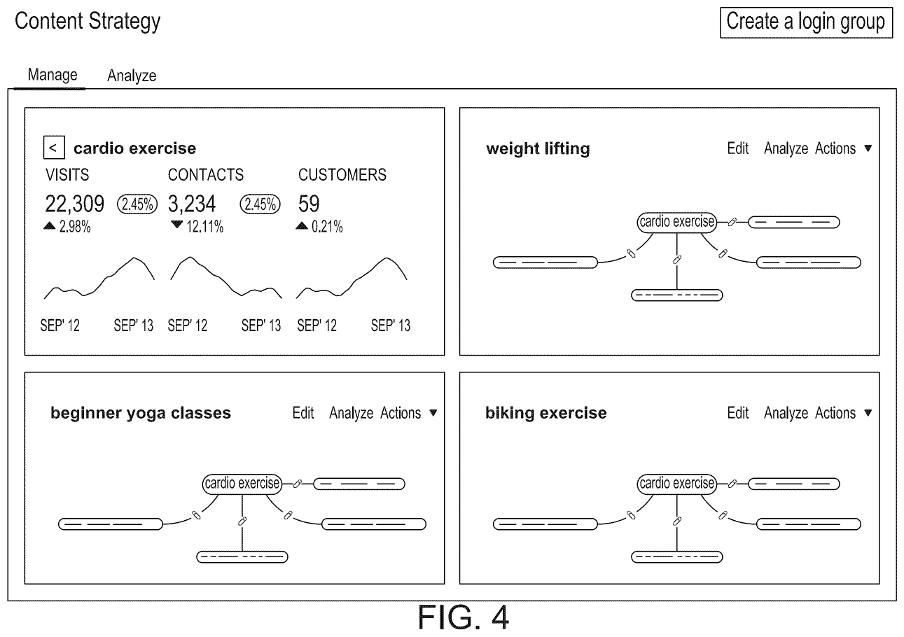

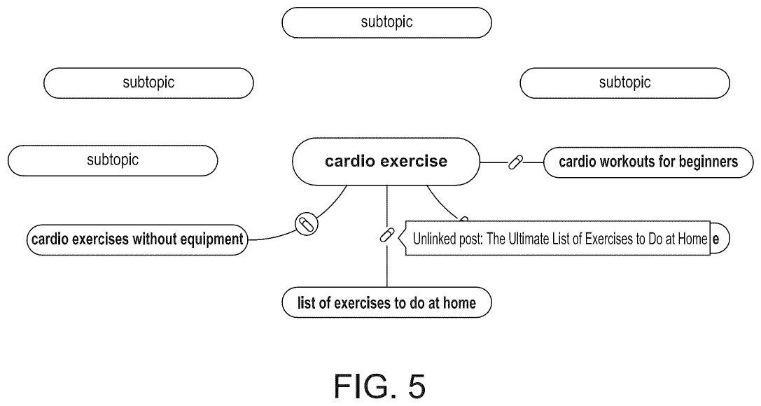

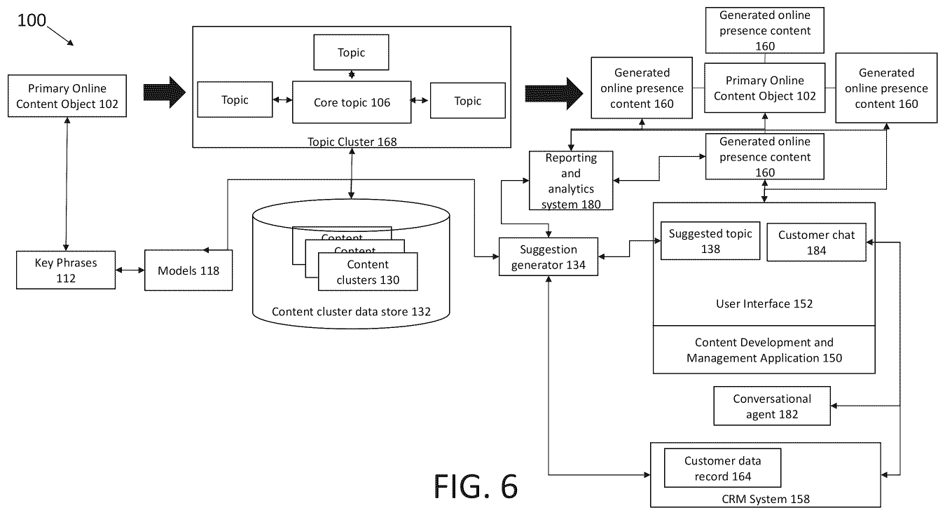

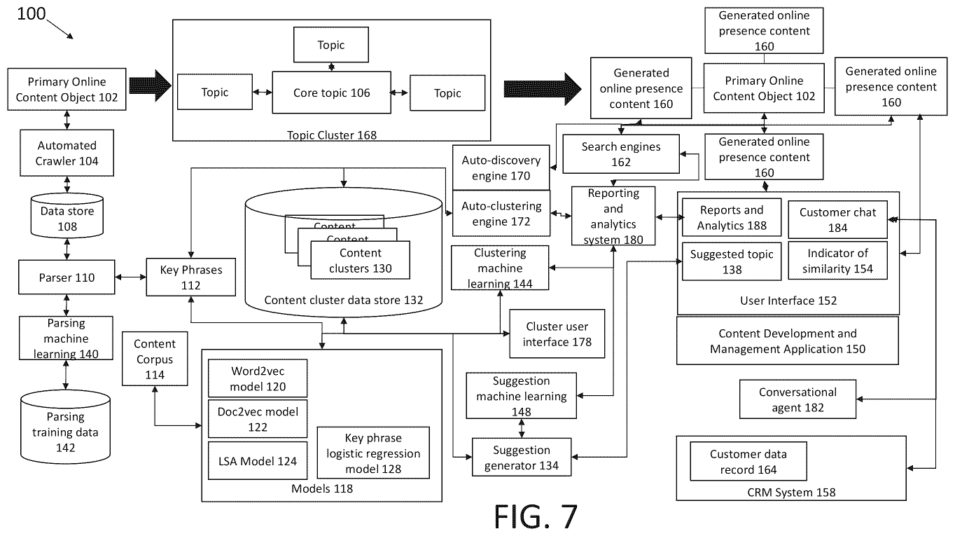

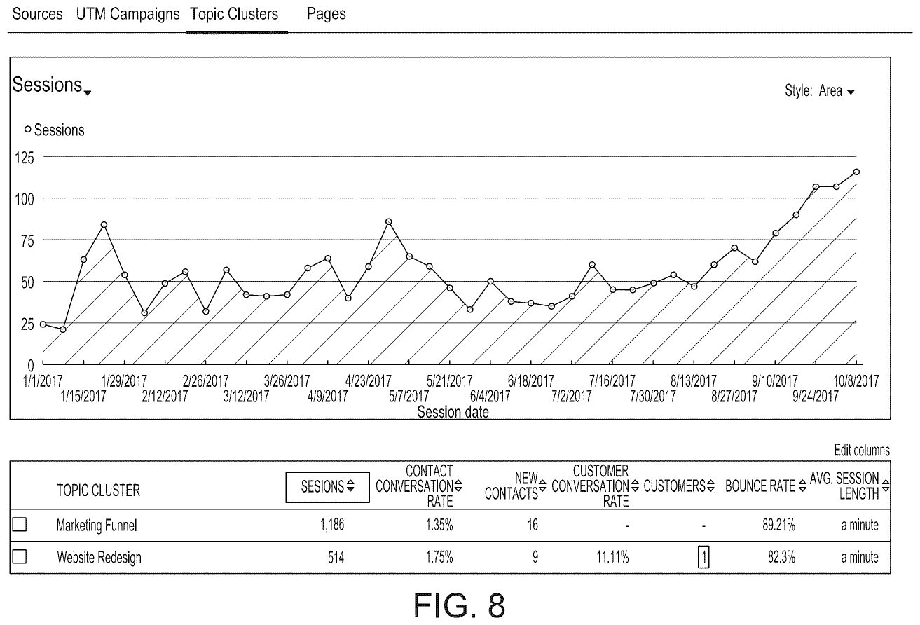

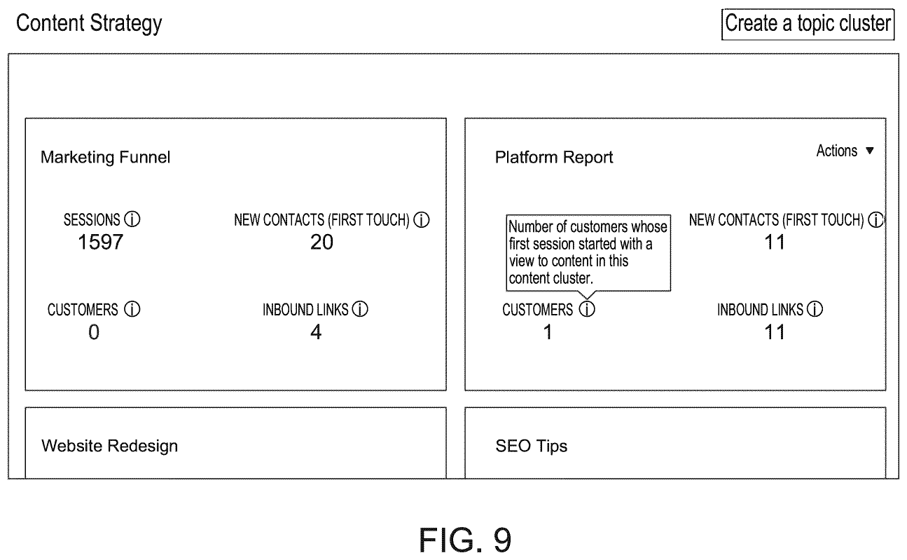

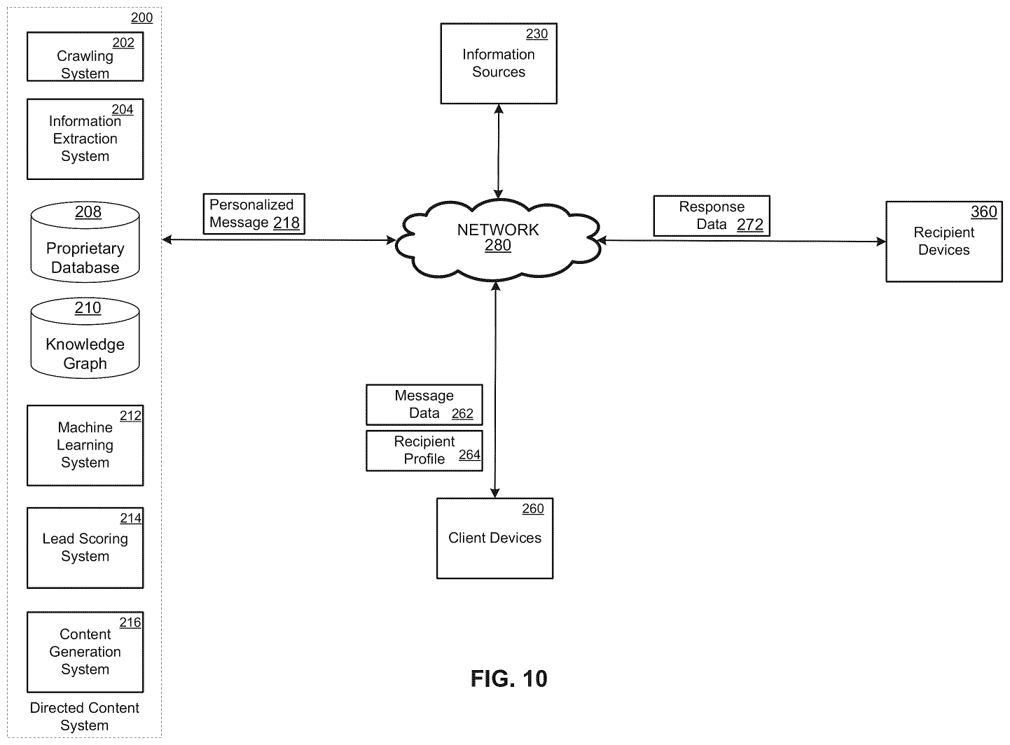

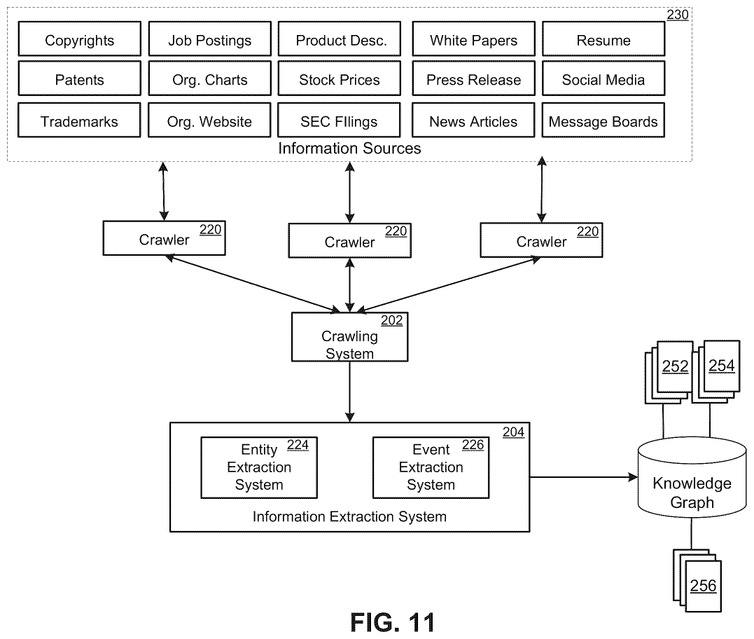

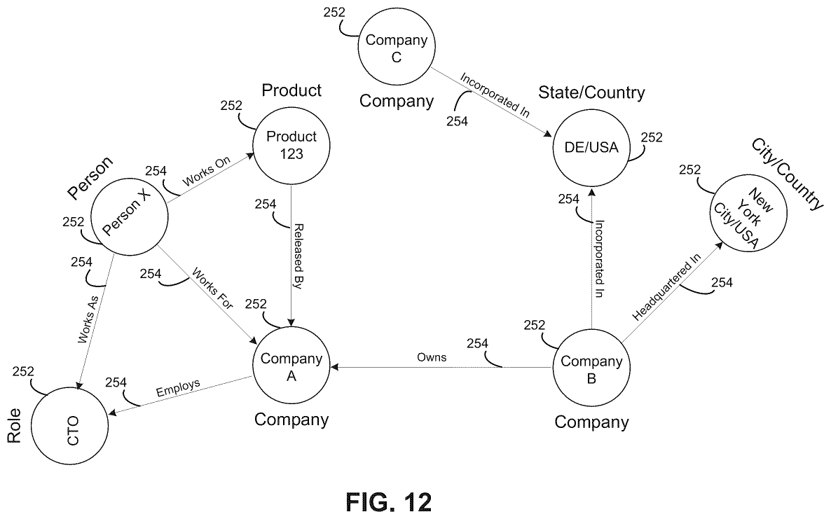

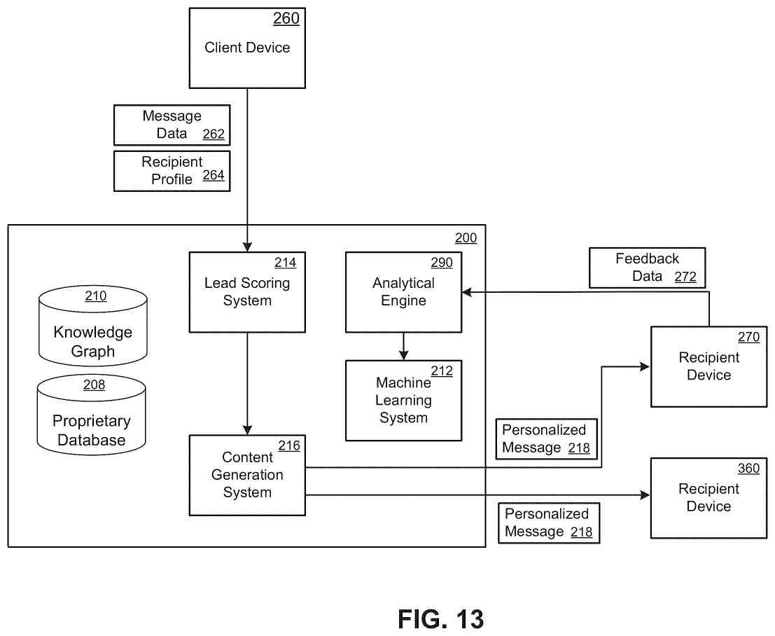

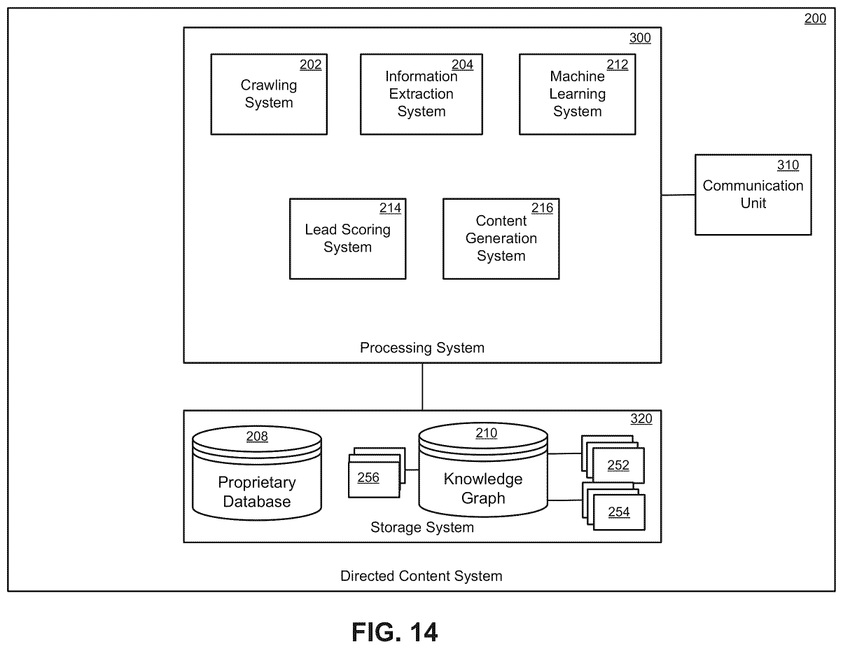

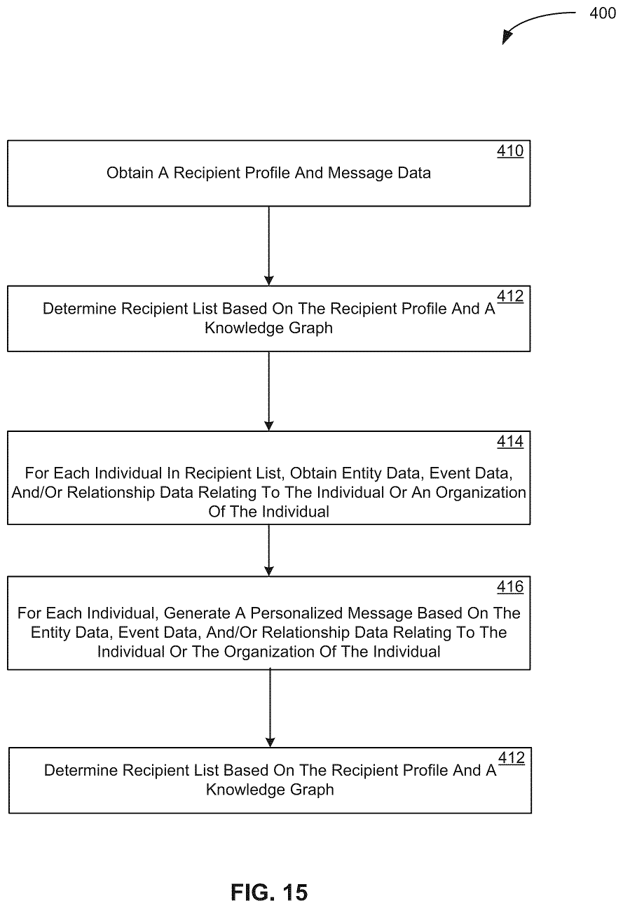

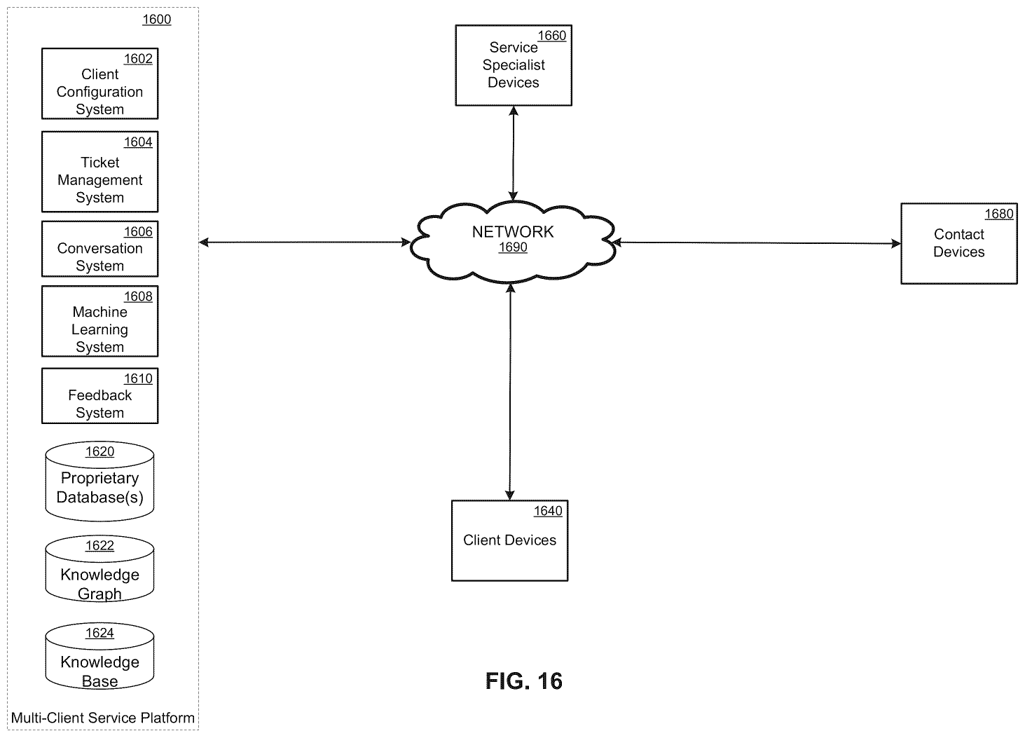

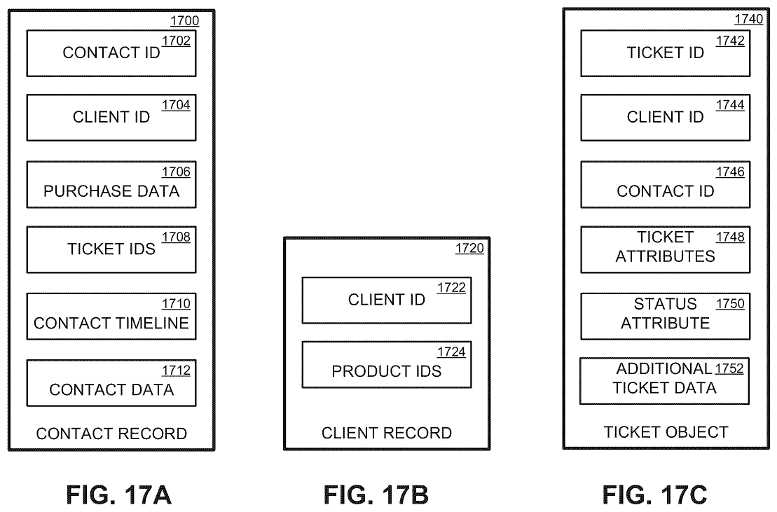

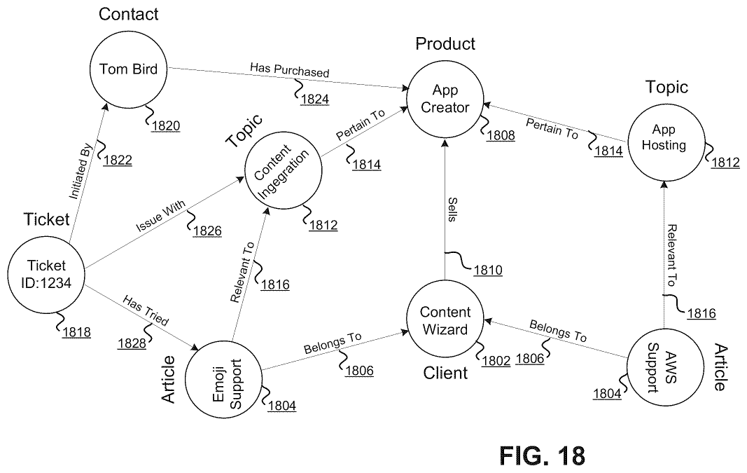

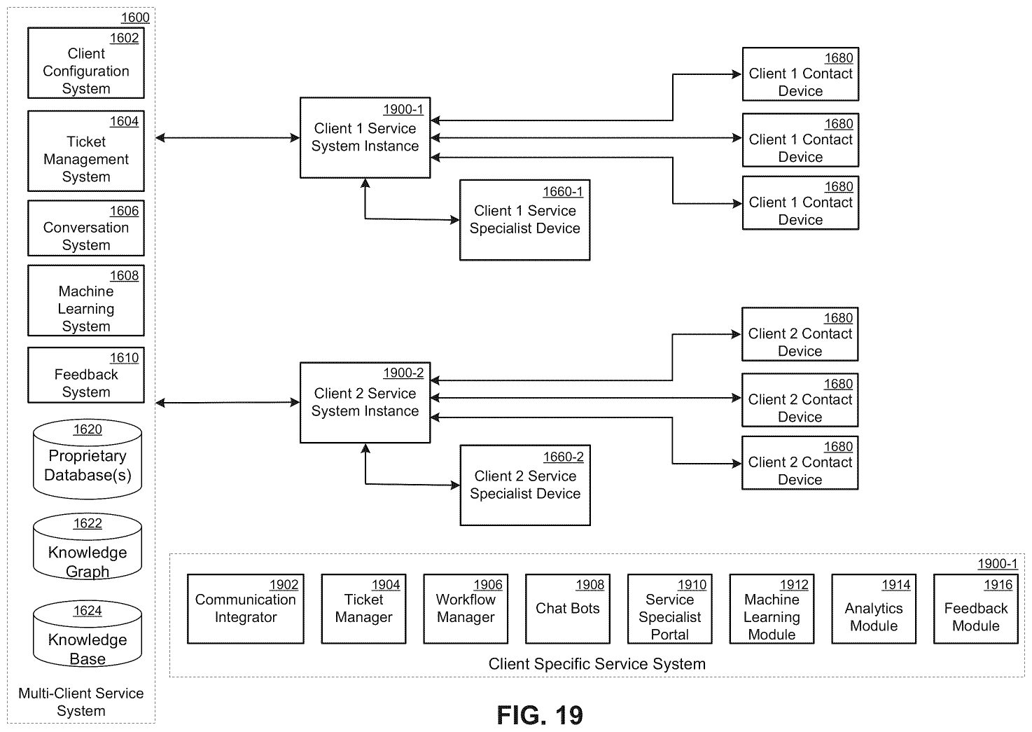

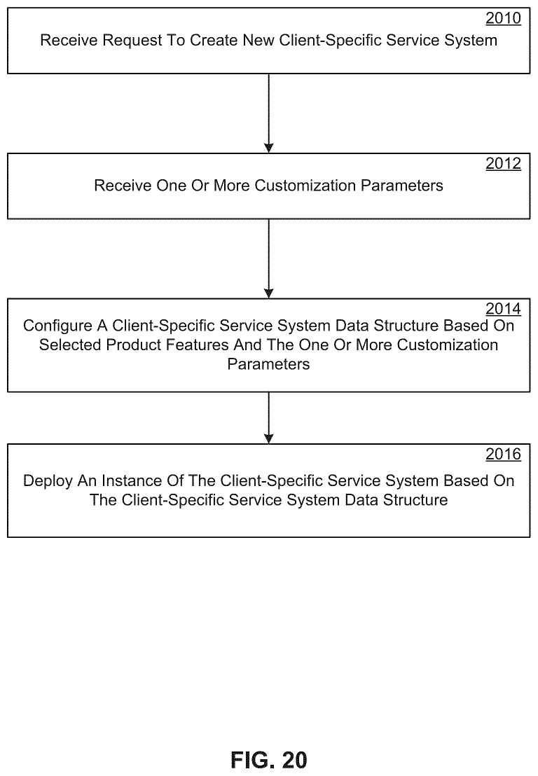

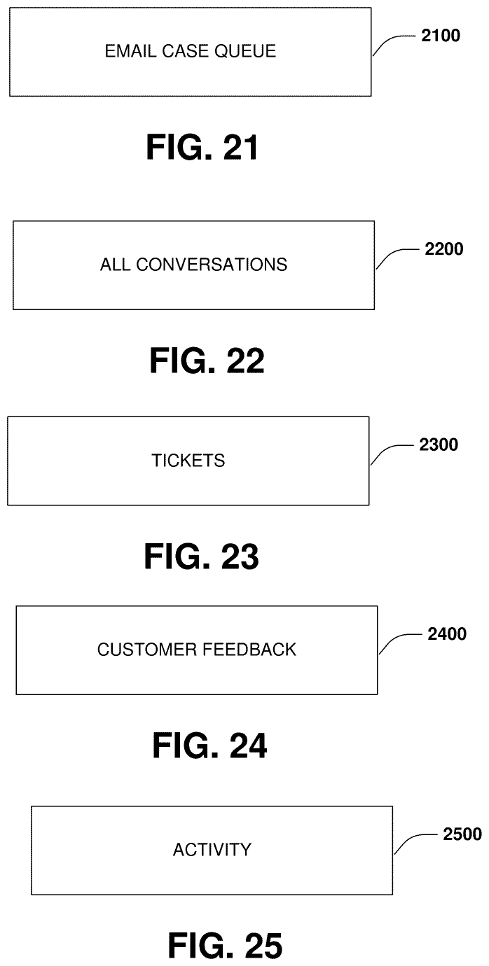

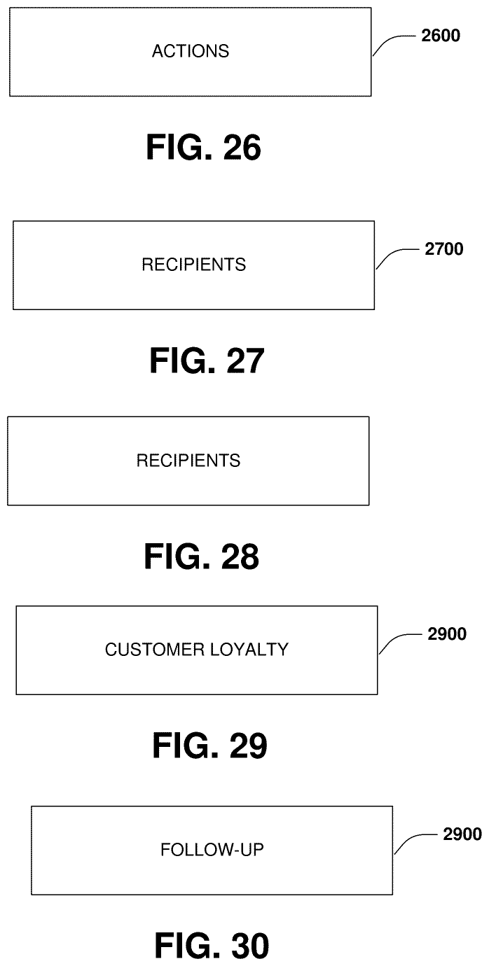

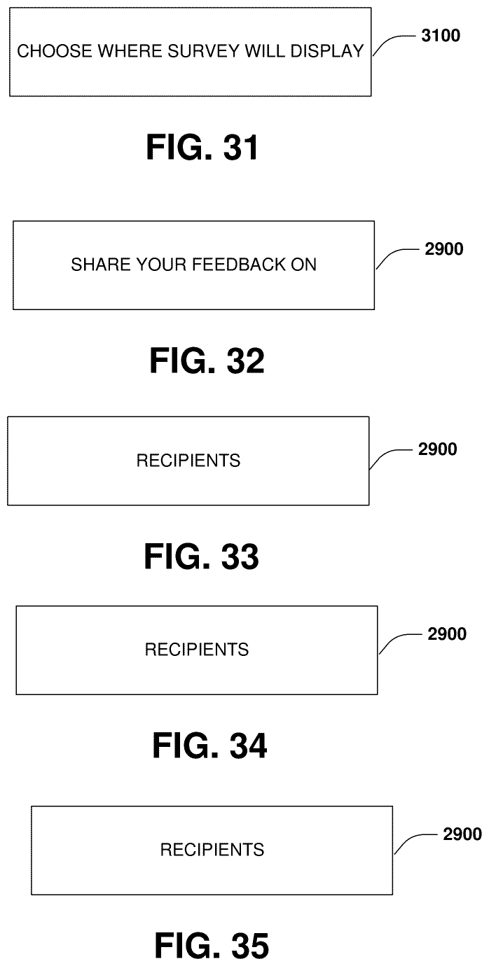

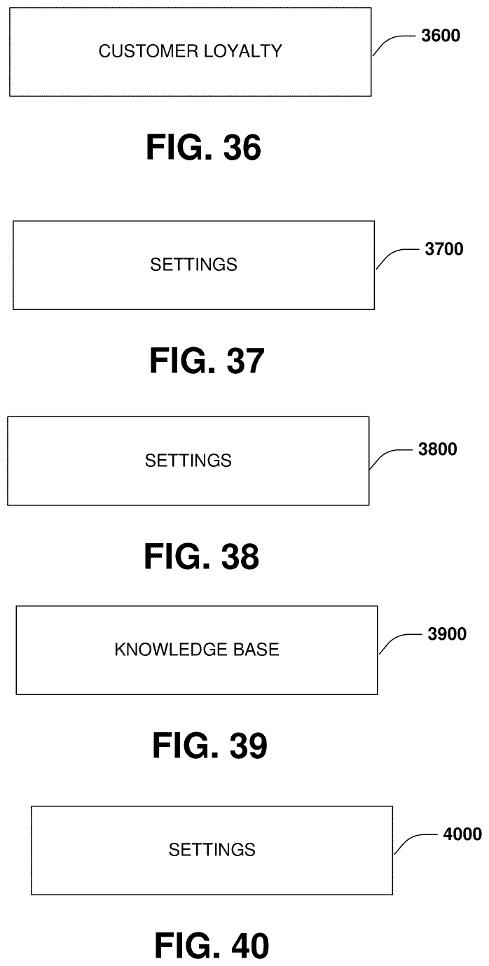

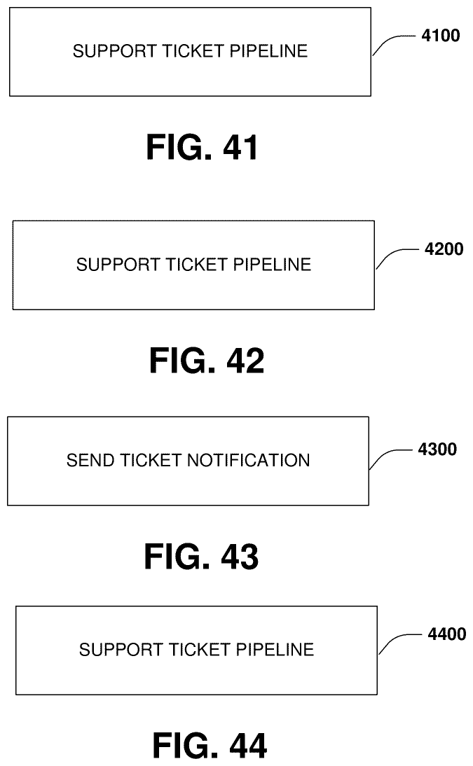

### DETAILED DESCRIPTION

The complex, difficult, and time-consuming tasks described in the disclosure may tend to deter use of information from one activity when conducting the other, except in a somewhat ad hoc fashion. For example, a person providing service to a customer may not know what product the customer has purchased, leading to delay, confusion, and frustration for the service person and the customer. A need exists for the improved methods and systems provided herein that enable, in a single database and system, the development and maintenance of a set of universal contact objects that relate to the contacts of a business and that have attributes that enable use for a wide range of activities, including sales activities, marketing activities, service activities, content development activities, and others, as well as for improved methods and systems for sales, marketing, and services that make use of such universal contact objects. The disclosure is directed to various ways of improving the functioning of computer systems, information networks, data stores, search engine systems and methods, and other advantages. Among other things, provided herein are methods, systems, components, processes, modules, blocks, circuits, sub-systems, articles, and other elements (collectively referred to in some cases as the “platform” or the “system”) that collectively enable, in one or more datastores (e.g., where each datastore may include one or more databases) and systems.

Further, a need exists for added and improved customizability with CRM systems and other-related systems for marketing and sales activities. While the CRM systems may use standard objects (e.g., accounts, contacts, leads, and opportunities), there is a need for the creation and use of custom objects. Specifically, there is a need for these systems to provide an ability for users to create custom objects relevant to the users' businesses. Also, there is a need for these systems to apply various types of features (e.g., apply processes such as analysis, reporting, workflows) to these custom objects.

In general, the disclosure provides a workflow system that has a custom workflow actions system (and related processes such as a custom workflow actions process) that may allow users to be able to create and set up a custom workflow. Specifically, this custom workflow actions system (e.g., and related processes) may allow users to create custom workflow actions that may be integrated as a service generally with the multi-service business platform 510 (e.g., integrated with other workflows). There may be existing automation platforms that provide similar capabilities. However, these other systems may provide this functionality as a piecemeal approach. Specifically, unlike these other systems, the custom workflow actions system may be fully integrated with the platform 510 (and all the other systems, data sources, services, etc. within the platform 510) which may provide full integration with the CRM, the ability to integrate with the CRM data, and all of the other tools that may be directly integrated into the platform 510. With the other automation platforms, users may have to separately determine how to integrate the custom workflow with other data and services (e.g., users may have to configure system(s) on their own to connect with other services and data). In contrast, the custom workflow actions system and related processes such as the workflow system process may already be integrated with the various services and data relating to actions in workflows.

### Workflow System

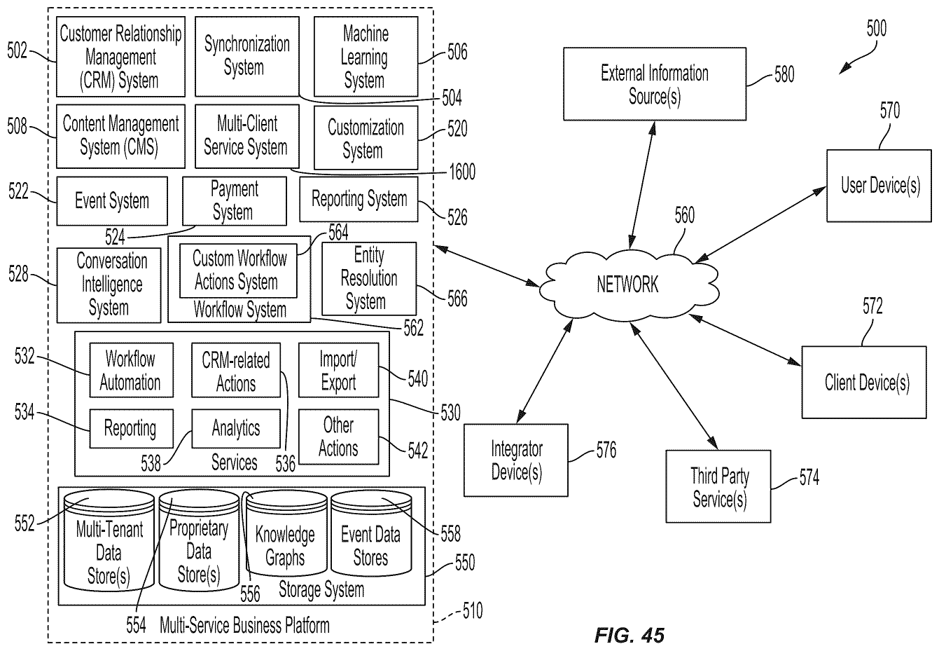

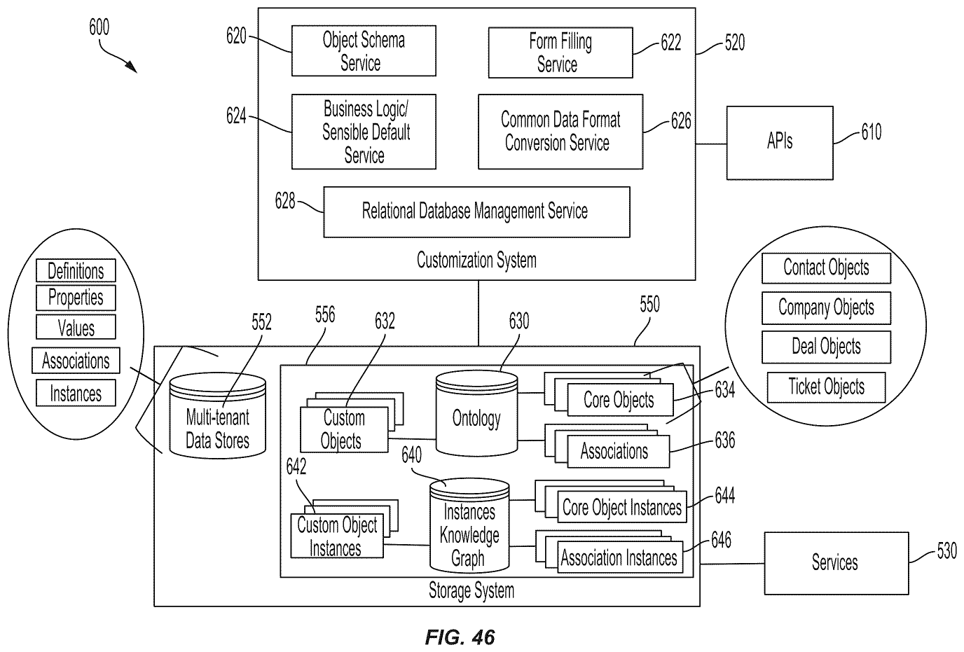

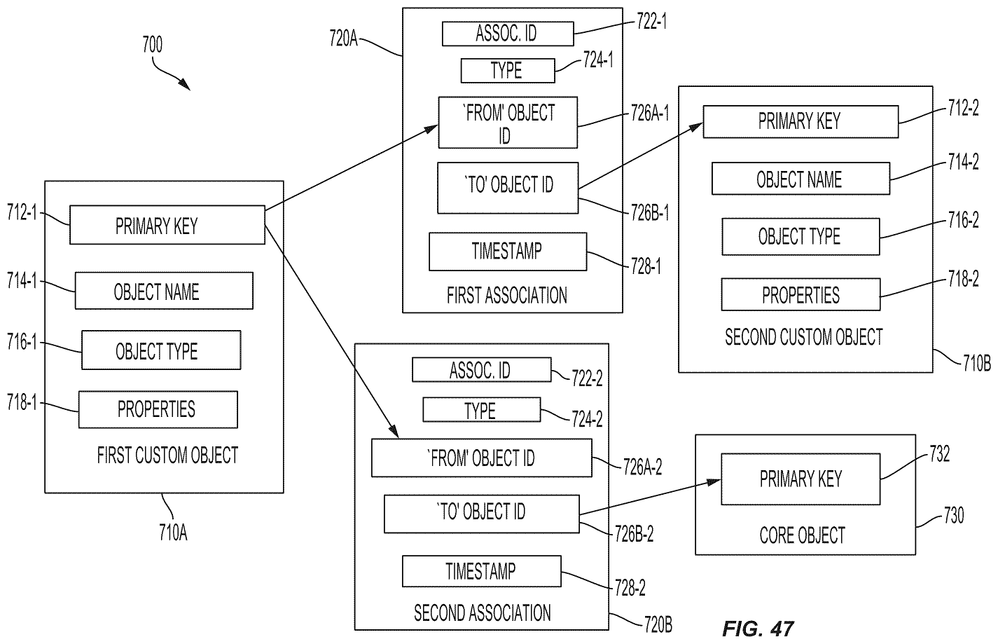

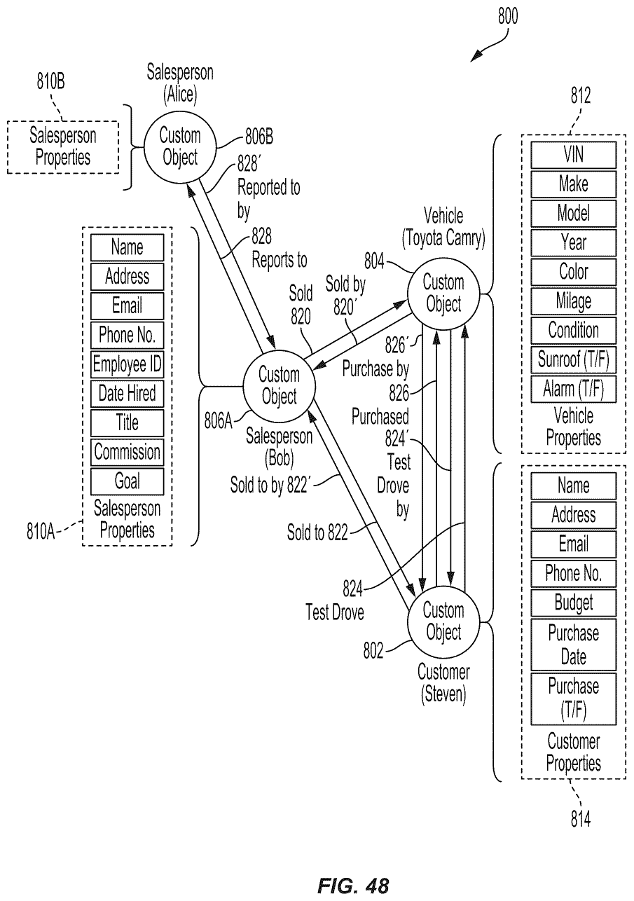

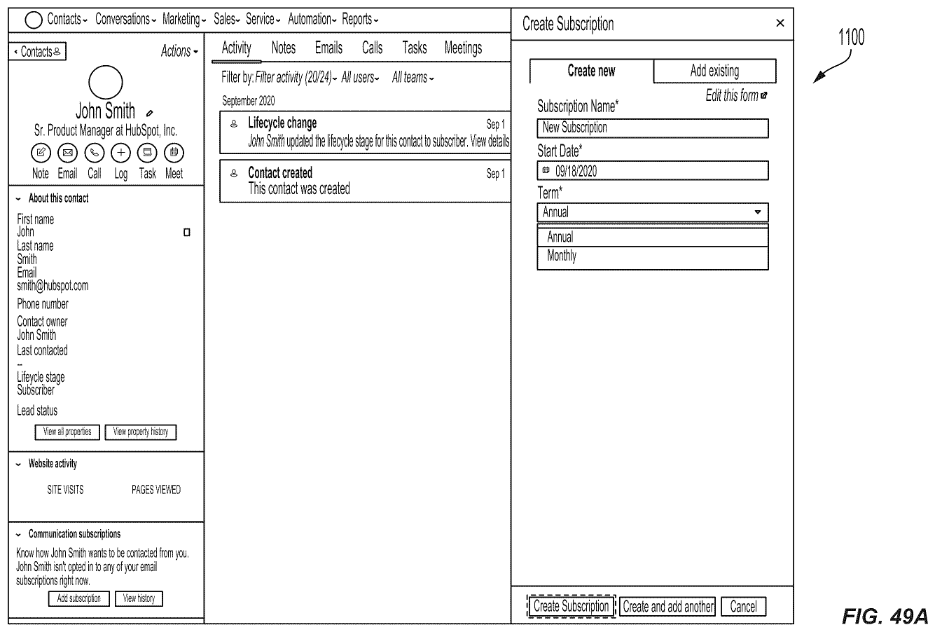

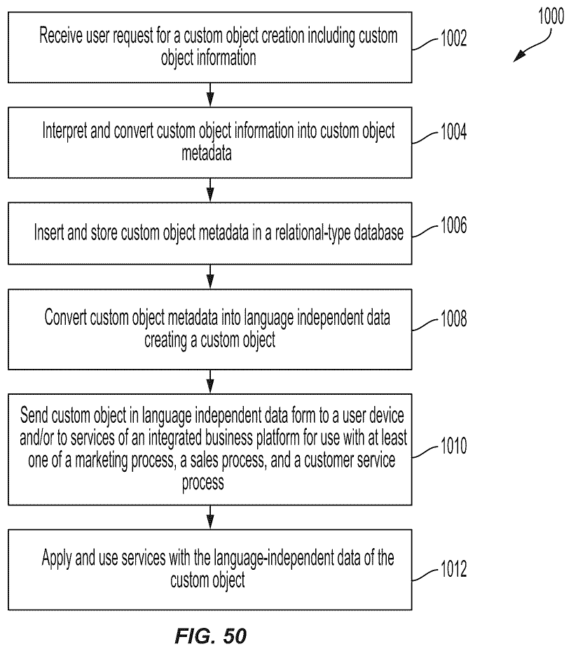

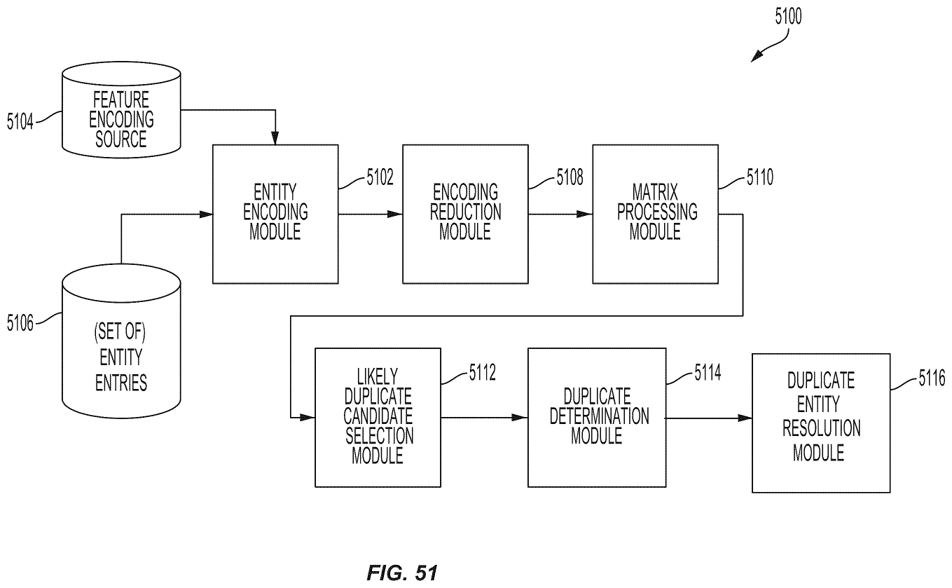

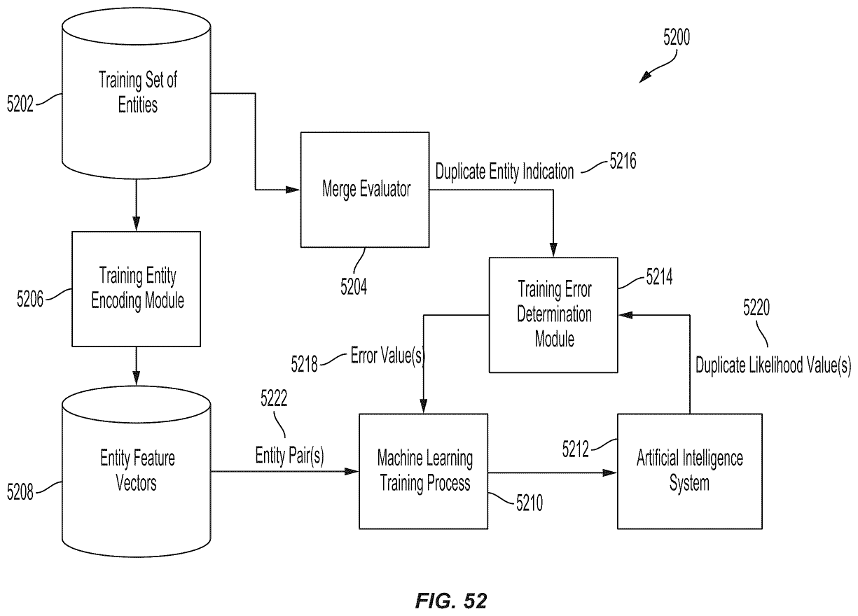

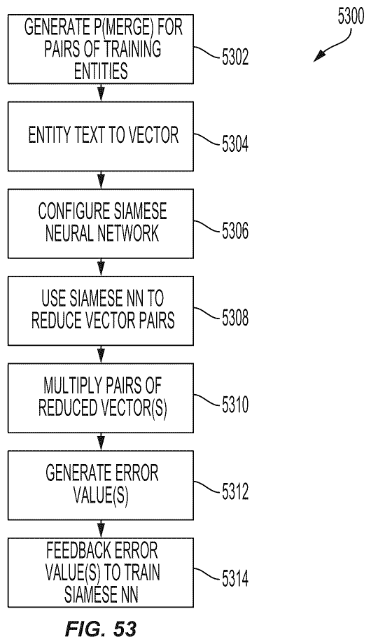

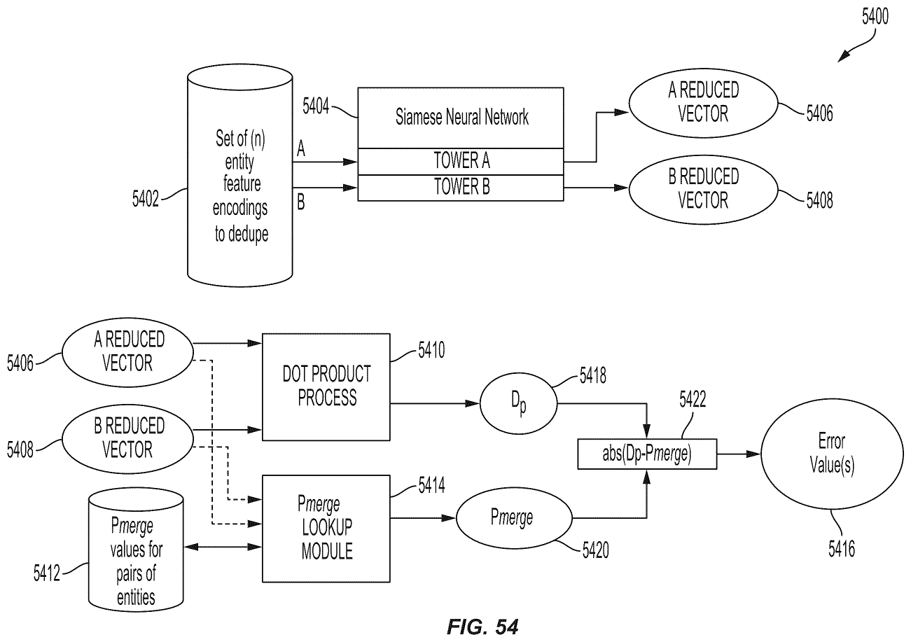

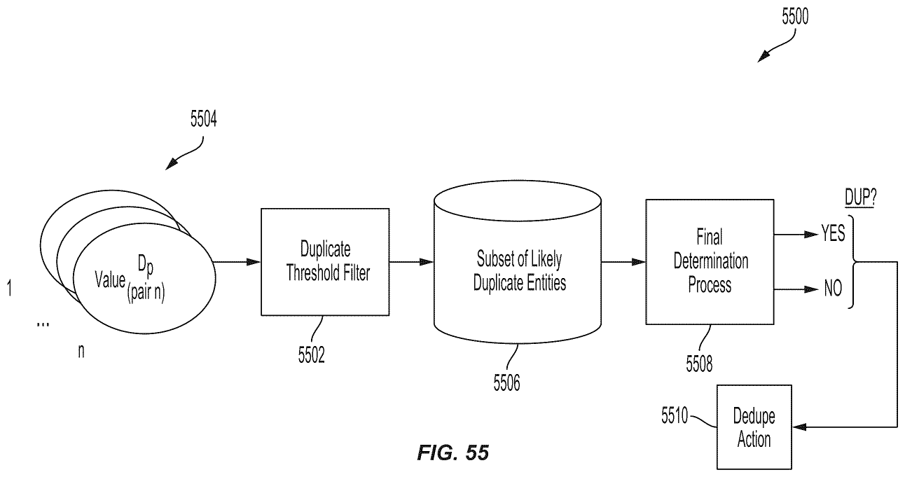

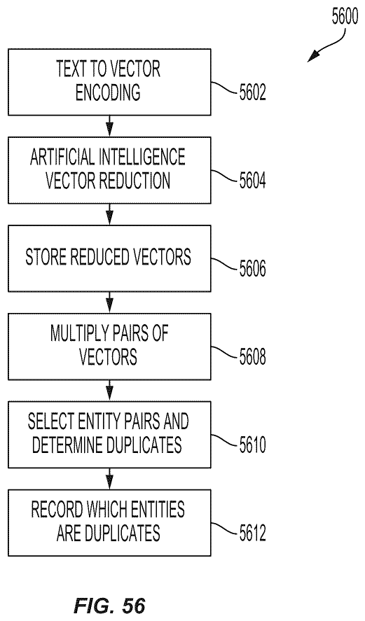

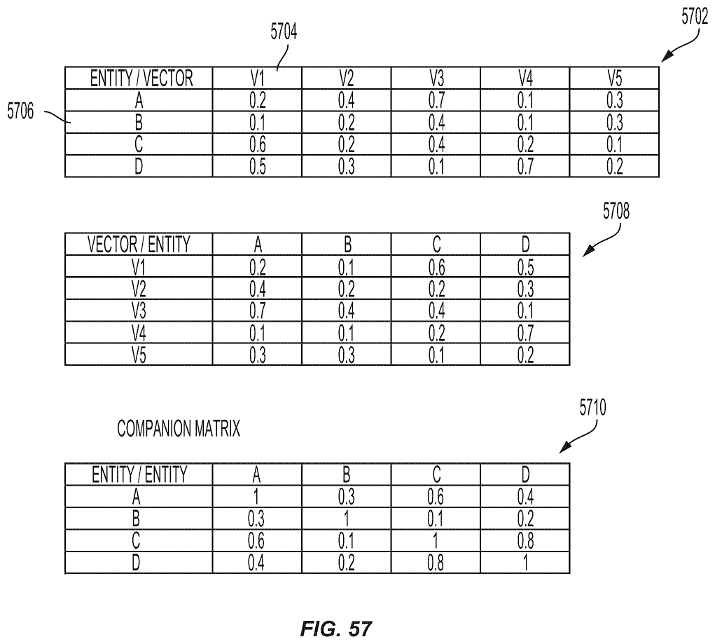

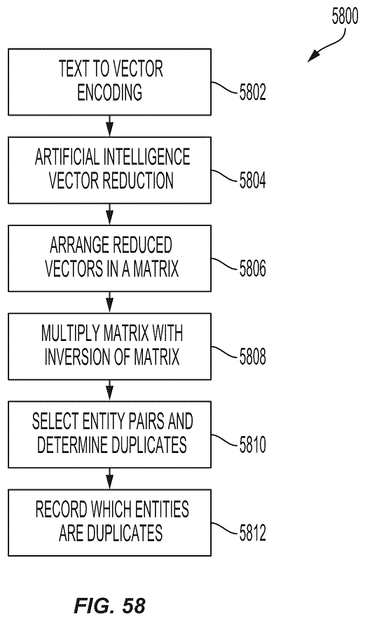

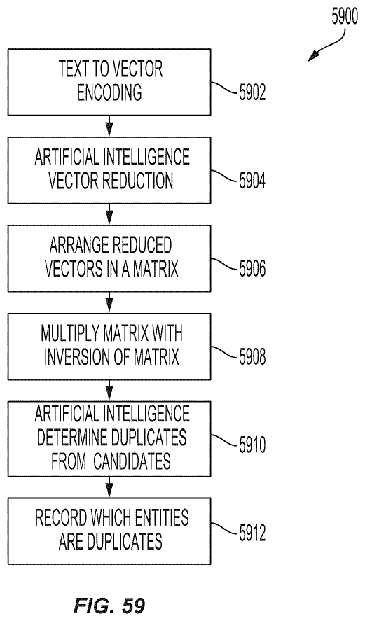

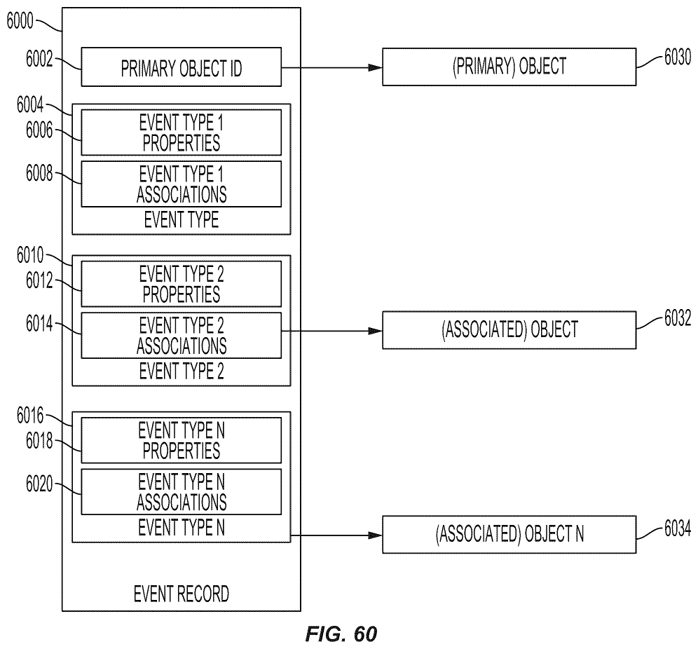

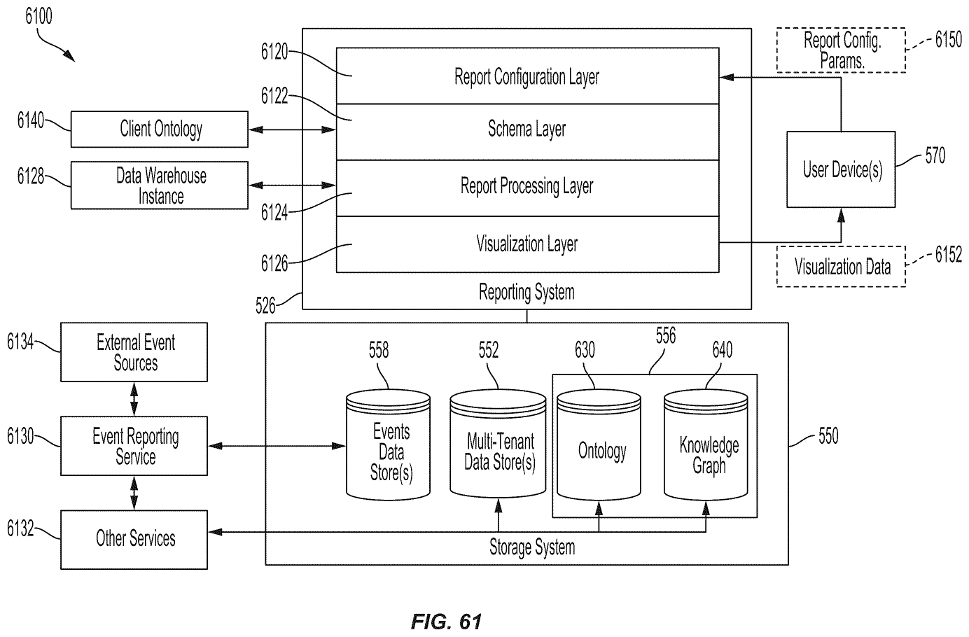

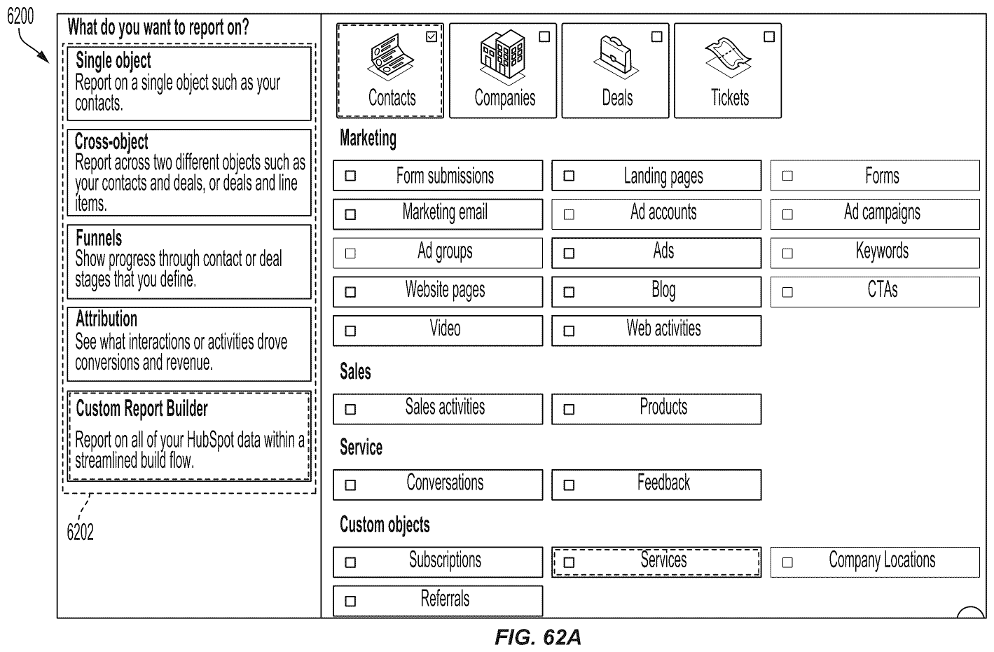

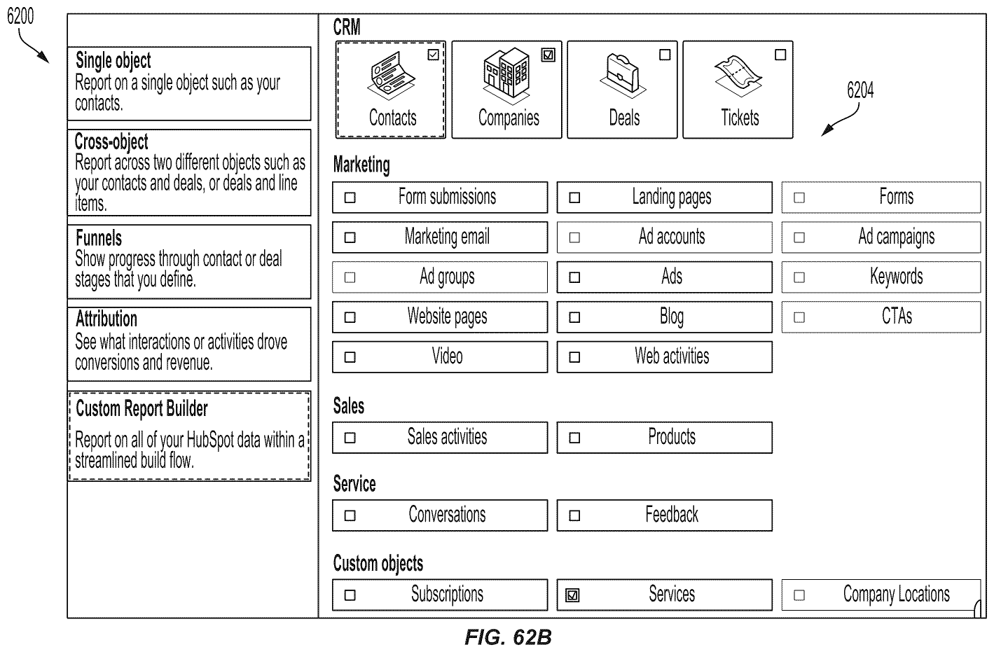

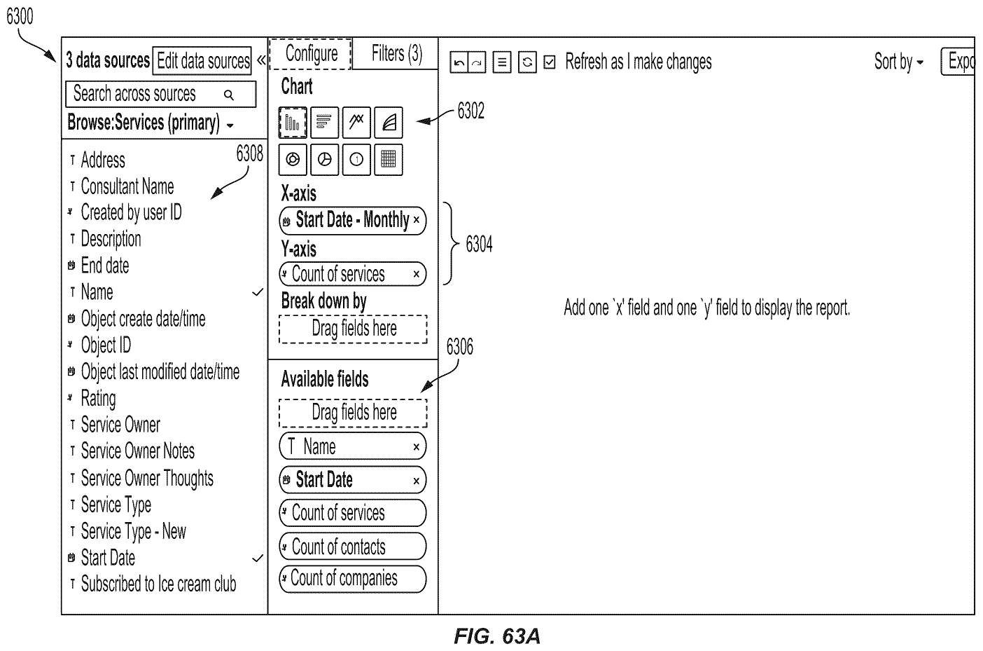

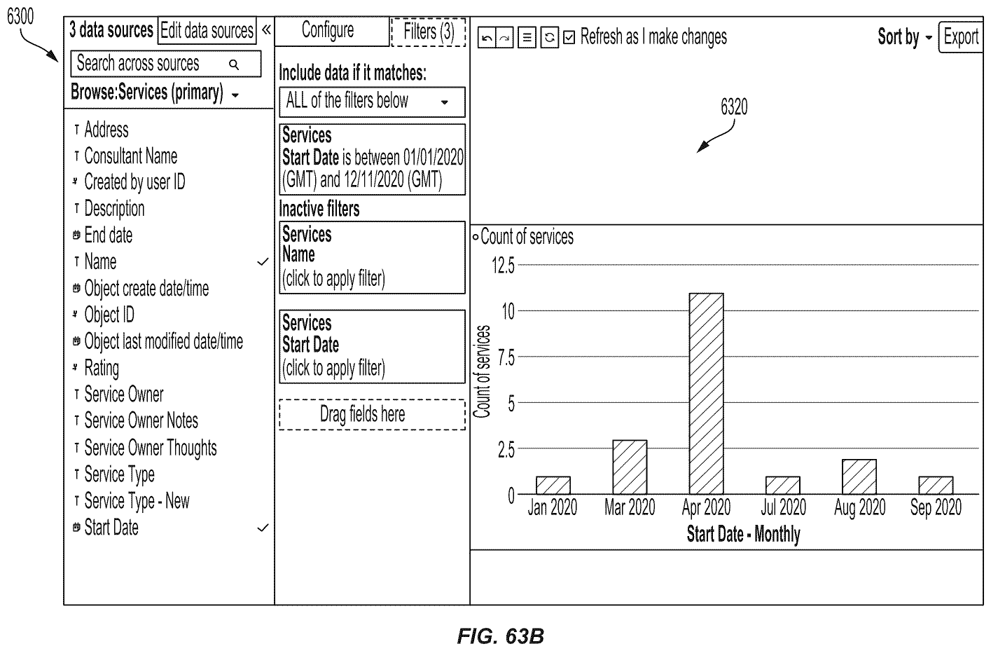

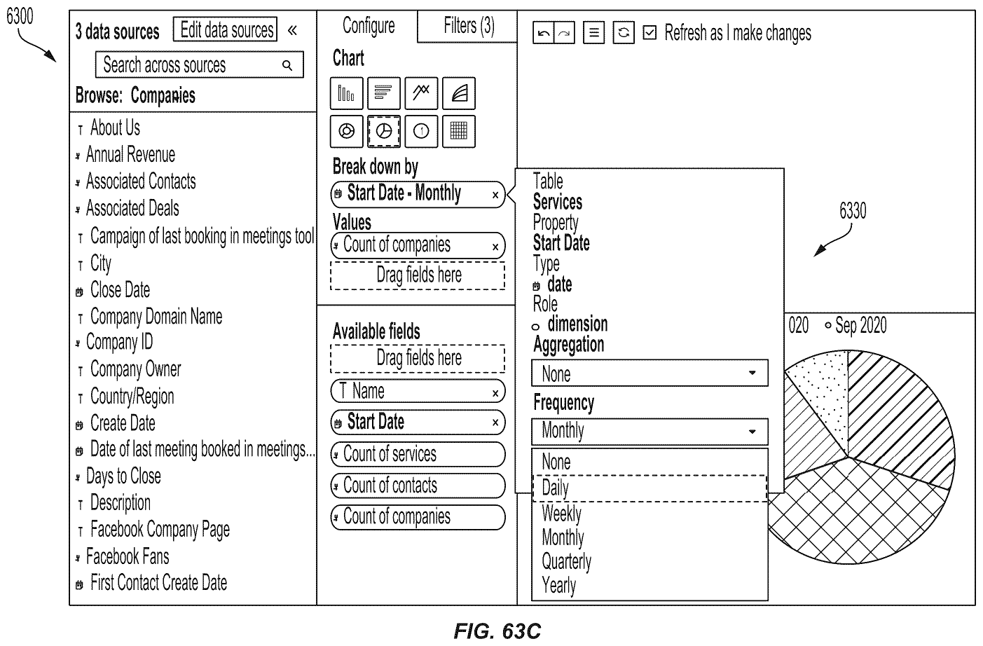

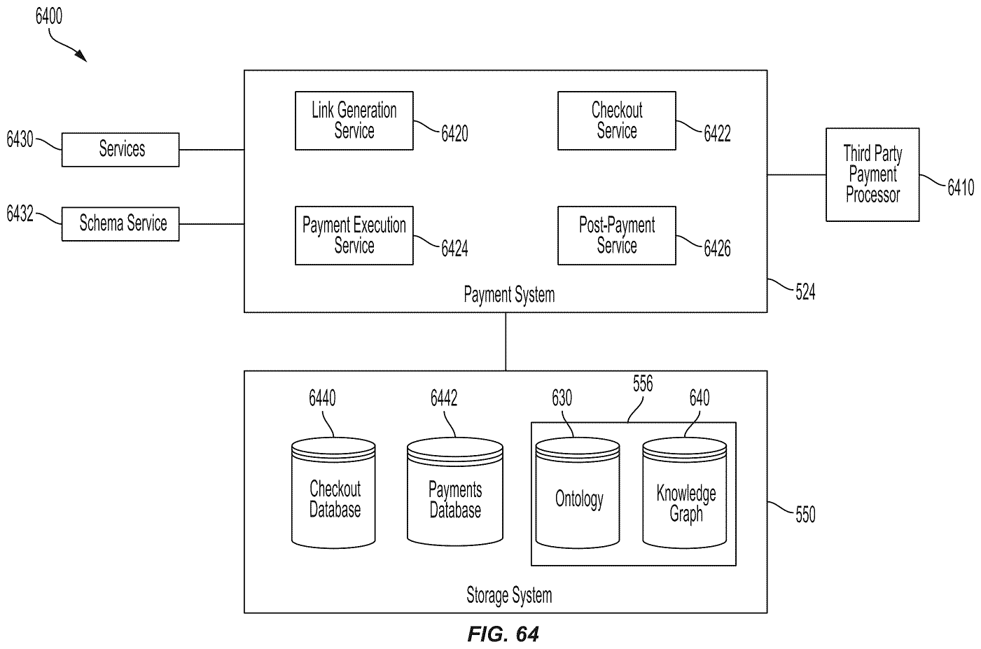

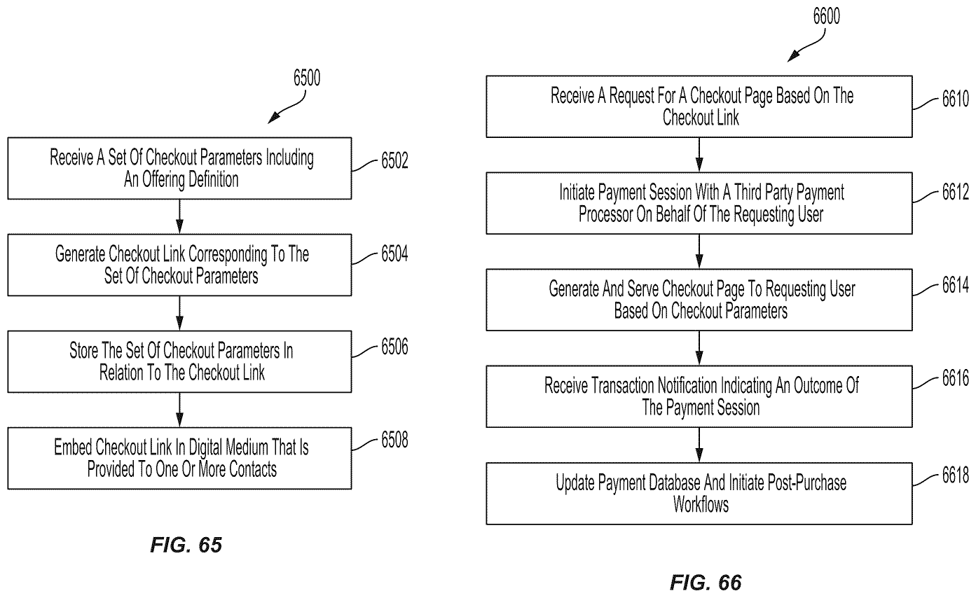

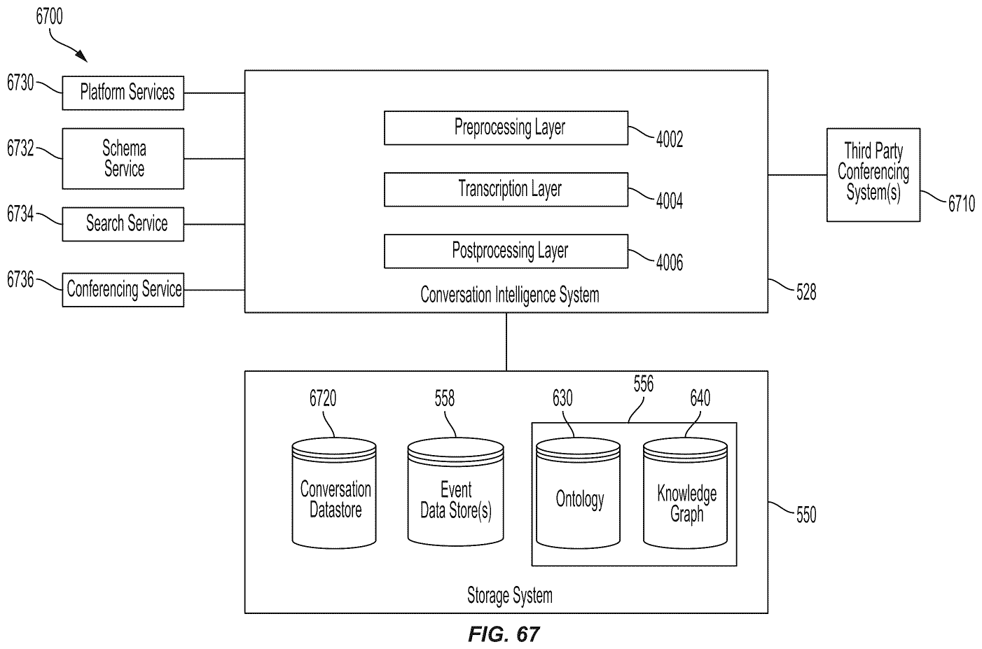

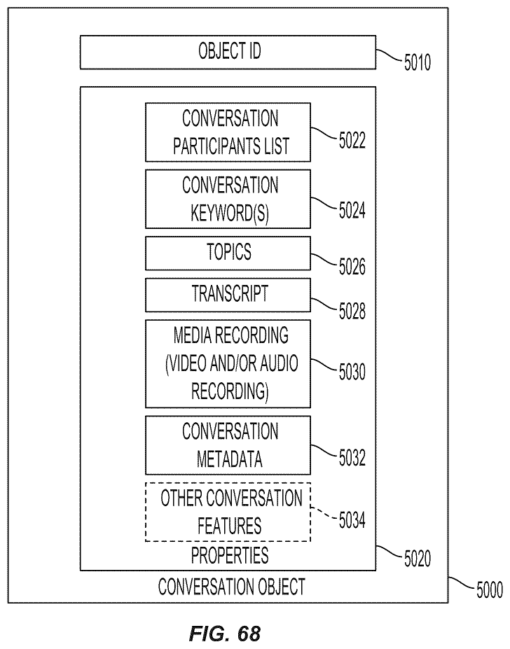

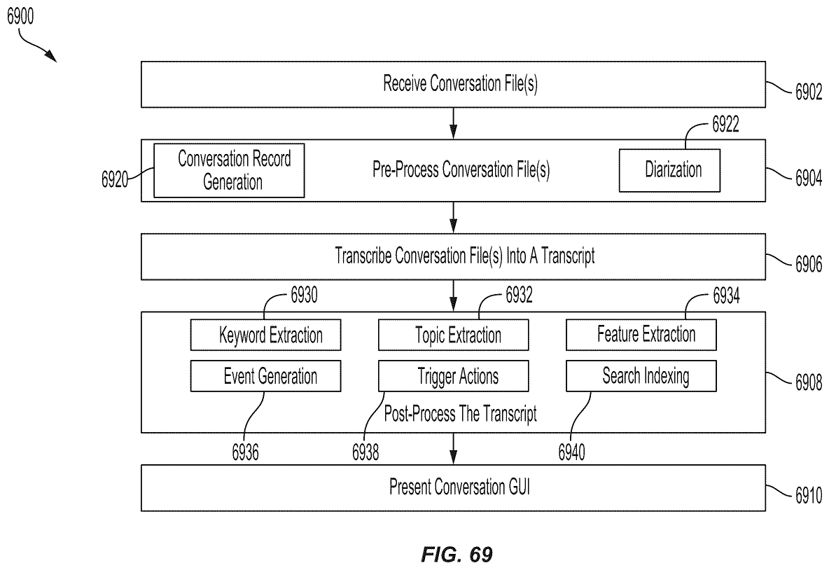

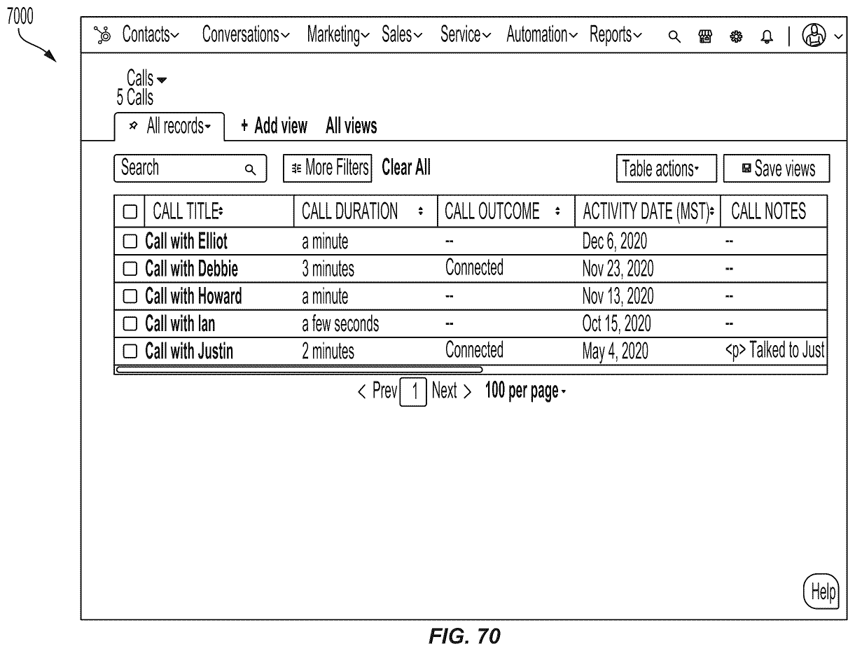

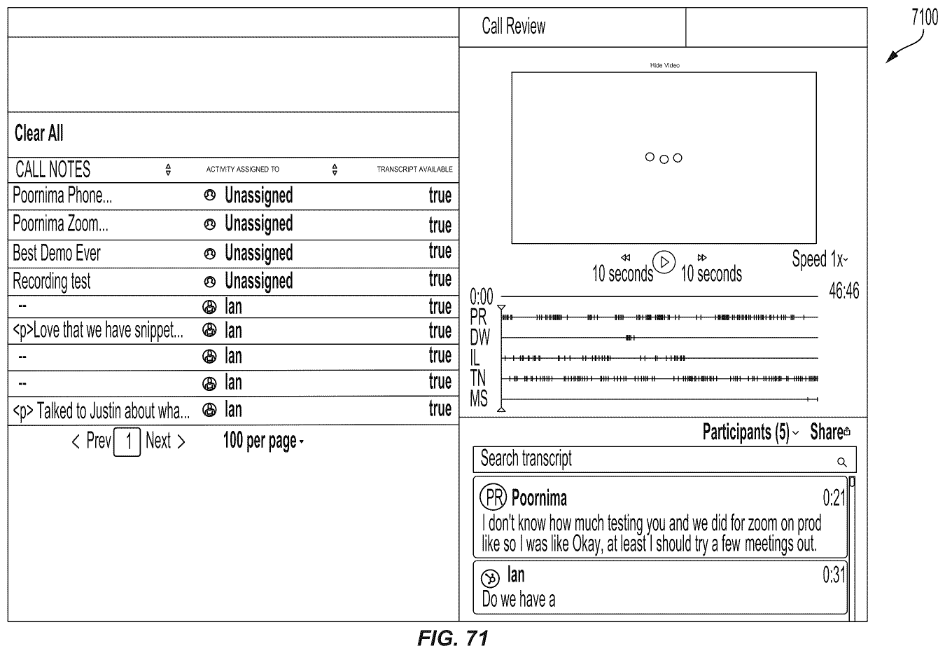

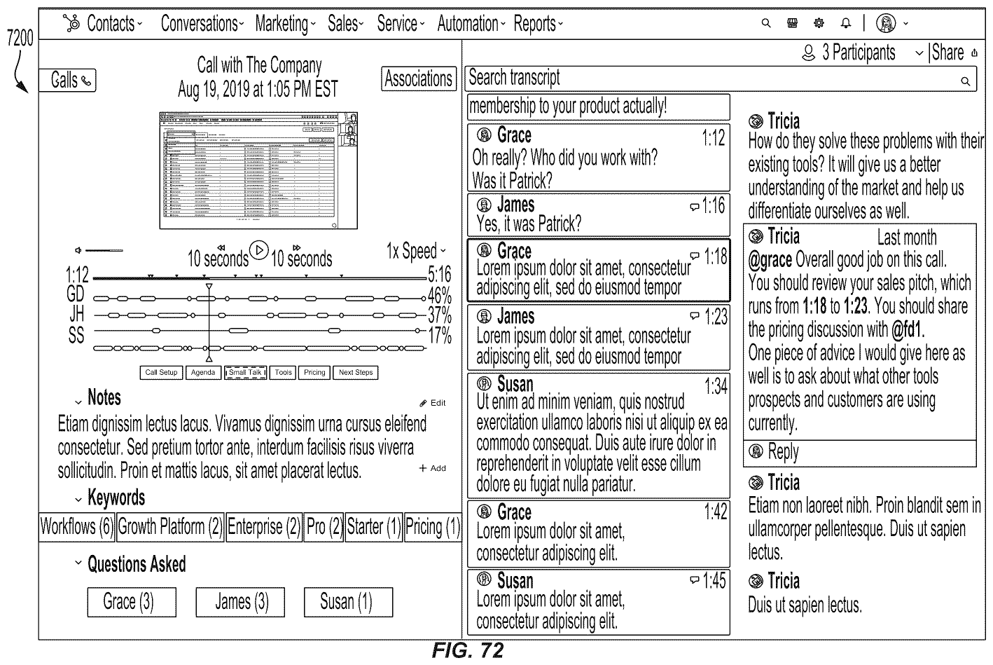

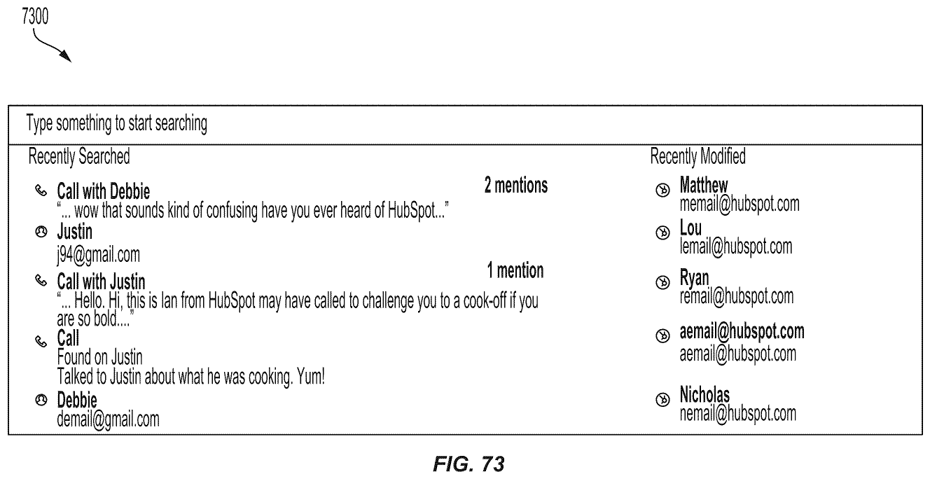

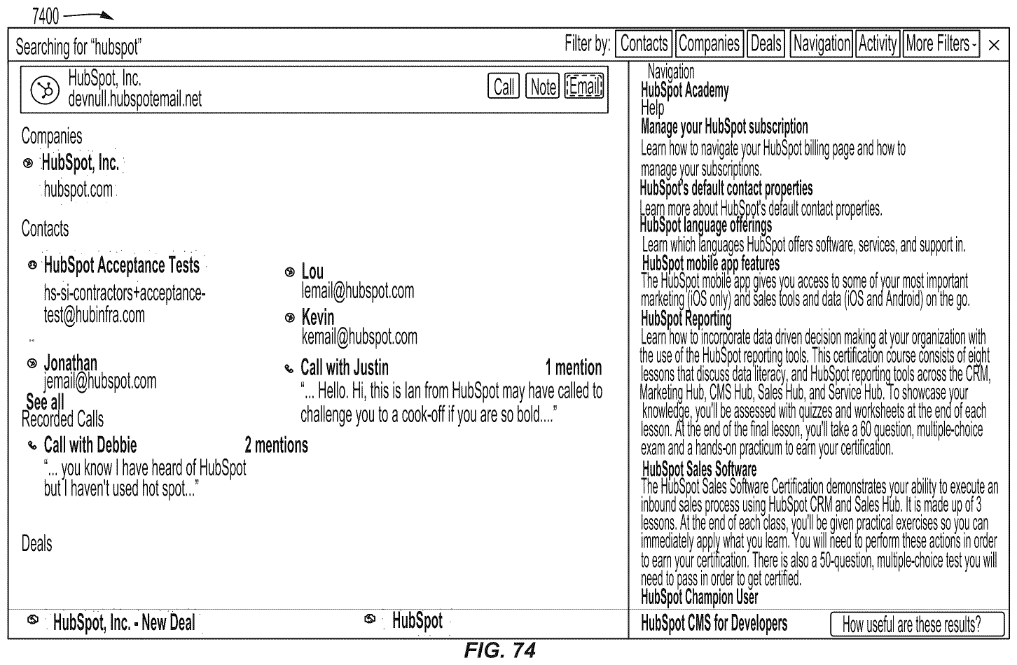

Referring now to an example implementation, FIG. 45 shows the example environment 500 including, in example embodiments, the multi-service business platform 510 having a workflow system 562. In example embodiments, the workflow system 562 may relate to controlling, configuring, and/or executing of workflows in the platform 510. In example embodiments, the workflow system 562 may utilize an automation application programming interface (API) which may provide “Get” functionality (e.g., get all workflows, get a specific workflow, get current enrollments, get performance stats for a workflow, and the like), “Post” functionality (e.g., enroll an object such as a contact into a workflow, create a workflow, using webhooks in workflows, and the like), “Put” functionality (e.g., log events), and “Delete” functionality (e.g., delete a workflow, unenroll or remove an object such as a contact object from a workflow).

### Custom Workflow Actions System

The workflow system 562 may include a custom workflow actions system 564 that may communicate with various systems, devices, and data sources according to one or more example embodiments of the disclosure. The custom workflow actions system 564 may provide users with the ability to create custom workflow actions (e.g., custom code actions). In general, the custom workflow actions system 564 may relate to a custom workflow action process for setting up a custom workflow action. Creating a custom workflow action may make it easier for users to integrate their services with other workflows on the multi-service business platform 510. In example embodiments, this process may include an initial definition of a custom action that may include expected inputs and a web address (e.g., uniform resource locator (URL)) that may be requested when the custom action is executed. Users may then install an application and add the custom action to their workflows. When the workflows execute, requests (e.g., hypertext transfer protocol secure (HTTPS) requests) may be sent to the configured URL with a payload that may be configured.

### Defining Custom Actions

In example embodiments, the custom workflow actions system 564 may allow users to define custom actions. For example, a custom action definition may include all information needed for workflows (e.g., needed for workflow system 562) to display the custom action in a workflows application. This same definition may also specify the request format for requests coming from other services, systems, data sources, etc. in the platform 510 as well as the handling of responses from these other services, systems, data sources, and the like. In example embodiments, the custom action definition may include: an action name (e.g., label given to the action in the workflows application) and action inputs (e.g., fields that may be filled out by a user to control the action's behavior and/or the selected values that may be included in the request that may be sent to the action web address such as “actionUrl”). The custom action definition may also include input options (e.g., define a set of valid values for the action inputs). In some examples, the input options may be optional for each field. In other examples, the input options may be either a static list or a webhook URL that may be provided. If the webhook URL is provided, the options may be fetched from that URL whenever the action may be edited by a user in the workflow actions system (e.g., workflows tool). In example embodiments, the custom action definition may also include an action web address (e.g., action URL “actionUrl”) and labels. An HTTPS request may be sent to the action URL whenever the action may be executed by the workflow system 562 (e.g., workflows tool). The request body may include information about which user the action is executing on behalf of, and what values may be entered for the input fields. The labels may be a user-facing copy that describes to the user what the action's fields may represent and what the action does. Labels may be specified in any number of languages (e.g., English, French, German, Spanish, etc.).

In example embodiments, the custom workflow actions system 564 may provide for a variety of other processes with respect to the defined custom actions. Validating requests may be made for the custom actions. In some examples, there may be default payloads (e.g., field option fetch) such that requests to fetch options may be made when a user may be configuring a custom action in a workflow. In some examples, if there is a desire to limit the number of options that may be returned by an option fetch, a pagination cursor may be set which may instruct the workflow system 562 (e.g., workflows tool) that more options may be loaded. The list of options may be made searchable allowing for results to be filtered by a search query (e.g., return “searchable”: true). In an example embodiment, execution requests may be made when a workflow may be executing a custom action against an enrolled object. For example, there may be input fields for workflows (e.g., contact and deal workflows) such that there may be a static input field (e.g., dropdown field with options) where one field may have a value for a platform user and another field may have a value pull from a property (e.g., as selected by a user for workflows) on the enrolled object.

Customizing Payload with Functions and Customizing Execution Requests

In example embodiments, requests made for custom actions may be customized by configuring serverless functions for the custom actions. For example, field option fetches may be customized such that there may be two hooks to customize a field option fetch lifecycle (e.g., using pre-fetch and post-fetch options functions). The pre-fetch options function (e.g., “PRE_FETCH_OPTIONS”) may allow the user to configure a request that may be sent from the platform 510 and the post-fetch options function (e.g., “POST_FETCH_OPTIONS”) may allow for the user to transform responses from the user's service into formats that may be understood by the workflow system 562 (e.g., workflows tool). In example embodiments, there may be a hook into an action execution lifecycle including a pre-action execution function (e.g., “PRE_ACTION_EXECUTION”). This function may allow users to configure requests that may be sent from the platform 510. In example embodiments, a custom action may use a serverless function to transform a payload that may be sent to a configured action URL (e.g., “actionUrl”). When no object types (e.g., “objectTypes) may be specified, this may be available for all types of workflows.

In an example embodiment, a custom action with field dependencies and options may be fetched from an API. For example, where a widget size may depend on widget color, a user may not be able to input a value for the widget size until a widget color is selected. A widget cost may also be dependent on the widget color but may be conditional on a value that the user selects for the widget color (e.g., a user may not input a value for widget cost unless “Red” is selected as the widget color).

In a blocking custom action example, a callbacks API may be used to instruct workflows to complete an action and have an enrolled object continue to next action in a workflow. In some examples, action blocks may not be specified when an action is created but may be determined by a response from a configured action URL (e.g., “actionUrl”).

### Publishing, Testing, Executing, and Blocking Execution of Custom Actions

In example embodiments, a custom action may be published. By default, the custom actions may be created in an unpublishable state and may only be visible in a developer portal associated with the platform 510 (e.g., platform application). To make the custom action visible, a published flag on the action definition may be initiated (e.g., made “true”). In example embodiments, the custom action may be tested such as by creating a workflow in the workflow system 562 (e.g., workflows app or tool) and adding the custom action. In example embodiments, the custom action may be executed such that a success of the custom action may be determined by examining a status code returned. For example, the status code returned may indicate that: the action completed successfully as indicated by the status code (e.g., 2xx status codes), the action failed (e.g., there may be some example exceptions where this may be indicating retries such as 429 Rate Limited status codes that may be retreated as retries and the Retry-After header may be respected) as indicated by the status code (e.g., 4xx status codes), or a temporary problem with service (e.g., action may be retried at a later time) as indicated by the status code (e.g., 5xx status codes). In some example embodiments, retries may occur through fetching of object properties using a platform API or by calling other platform API endpoints. In example embodiments, custom actions may block workflow execution. This means that instead of executing the next action (after the custom action) in the workflow after receiving a “completed” response (e.g., 2xx or 4xx status code), the workflow may stop executing (“block”) until the workflow may be instructed to continue. In example embodiments, a blocking execution may be kicked off or a blocked execution may be completed. In example embodiments where a blocking execution may be kicked off, a custom action may be blocked asynchronously. There may be an expiration that may be a default duration after which the custom action may be considered “expired”. At this stage, execution of the workflow may resume and an action following the custom action may be executed even though there may not be an instruction for the workflow to continue.

### Logging and Defining Outputs

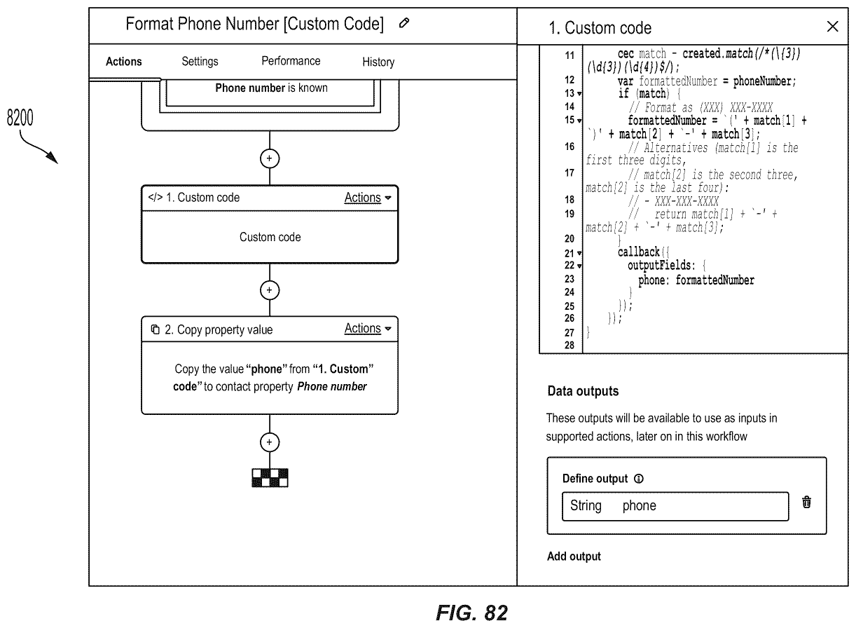

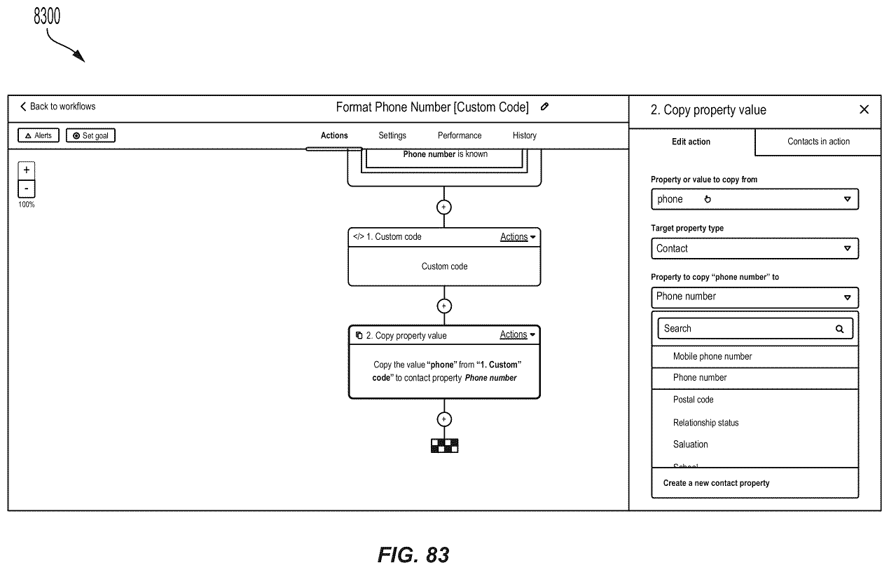

In example embodiments, the workflow actions system 564 may allow for developers to print outputs from their code as part of logging. It may help debug issues and may provide support for end users. Output of logs may be viewed and found in a “History” tab of the workflow as shown in FIG. 82 and as described in further detail in the disclosure. In example embodiments, outputs may be defined. For example, a function may define output fields that may be used later in the workflow. Then, the data output type (e.g., number, string, boolean, datetime, enum, date, phone number) may be selected in a user interface (UI) such as by inputting a field preferred for output. The output fields may be part of a JavaScript Object Notation (JSON) object in some examples. In example embodiments, to define data outputs that may be used as inputs in a workflow, “Data type” may be clicked from a “Data outputs” dropdown menu and type of data may be selected (e.g., name for data output may be provided in “Name” field and multiple outputs may be added by clicking “Add output”). The output from the code action may be used as input to a “copy property” action as shown as “copy property value” in FIG. 83 as described in further detail in the disclosure. This may remove a need to make another API call to store a value as a property on an object.

### Example Use Cases

In example embodiments, there may be a variety of use cases for the workflow actions system 564. Some example use cases may include: transforming data (e.g., turning a string into a date/time object such as “date_time” or changing a formatting of a phone number), data hygiene (e.g., name capitalization, name concatenation, etc.), lead assignment, territory management, service-level agreement (SLA) management for service issues, customizing webhook payloads (e.g., change format of a request that may get made for a webhook action, and with the custom code action (and the requests library)), and/or the like. In some example embodiments, random number generator functions may be used (e.g., cryptographically secure pseudo-random number generation) such as with respect to enrolling objects into a workflow.

### Custom Workflow Actions Process

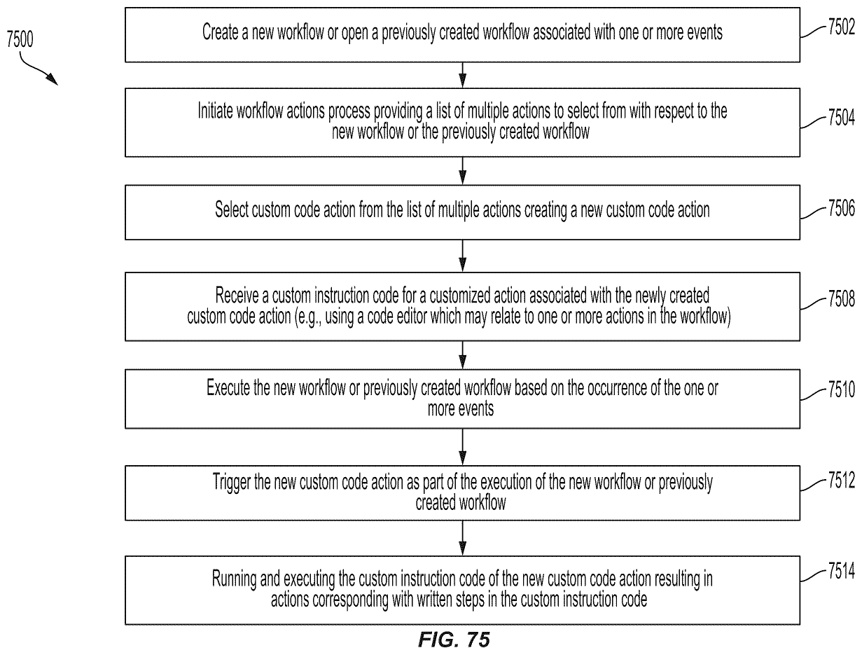

Referring now to FIG. 75, there is shown a flowchart 7500 having an example set of operations for creating and using a custom workflow (specifically creating and using a custom action process such as a custom code action process). In the illustrated example of FIG. 75, the process includes creation of a new workflow or opening a previously created workflow associated with one or more events at 7502. A workflow actions process may be initiated providing a list of multiple actions (e.g., action types) to select from with respect to the new workflow or the previously created workflow at 7504. A custom code action may be selected from the list of multiple actions creating a new custom code action at 7506. Next, a custom instruction code for a customized action associated with the newly created custom code action may be received from a user (e.g., a user may use a code editor which may relate to one or more actions in the workflow) at 7508. The new workflow or previously created workflow may be executed based on the occurrence of the one or more events at 7510. Then, the new custom code action may be triggered as part of the execution of the new workflow or previously created workflow at 7512. Running and executing the custom instruction code of the new custom code action may result in actions corresponding with written instructions (e.g., steps) in the custom instruction code at 7514.

### Custom Workflow Actions System-Events

In general, the custom workflow actions system 564 (e.g., custom code workflow actions tool) may allow users to create workflows that respond to events so that the users may customize any action that they want after an event has taken place. The custom workflow actions system 564 may function within a custom workflow actions process. Other related actions and/or functions may also be included in the custom workflow actions process. In example embodiments, events may be defined generally as some change in the platform (e.g., multi-service business platform 510). For example, this change may be a property change on a contact or anything that may drive a list change. Then, the multi-service business platform 510 may take an action on any number of user-configured actions. For example, the multi-service business platform 510 may be used to configure or set properties, send emails, send notifications, call other URLs in other companies, and the like. In example embodiments, other actions may be taken within the scope of this disclosure providing a relatively broad list of actions that may be taken. Some examples of events of extensions may include create a ticket (e.g., an issue tracking ticket such as a Jira ticket), or create an Asana ticket, or call out a webhook to a third-party company or internally, etc. In other examples, messages may be sent through various channels (e.g., send Slack messages).

### Custom Workflow Actions System-Custom Code

In example embodiments, the custom workflow actions system 564 uses a custom code action. Specifically, in example embodiments, the custom workflow actions system 564 may provide the ability for users to write their own code and may execute arbitrary logic in response to the code. This may be a graphical programming language where there may be a condition (e.g., if/then statement). The custom code action allows users to author arbitrary logic to do whatever the user wants when an action shows up (e.g., using JavaScript). There may also be data passing between actions such that one action occurs and then there may be a result from that action. This result may be passed to another second action such that the second action may act on the result that may be used as part of the input of what it may be doing. In another example embodiment, the custom workflow actions system 564 may use formula actions which may be relatively simple custom code actions (e.g., performing or providing data hygiene processes such as capitalization of names, spell checking, etc.). These actions (and related processes) may stem from the ability to execute an arbitrary process when an action takes place.

### Custom Workflow Actions Examples

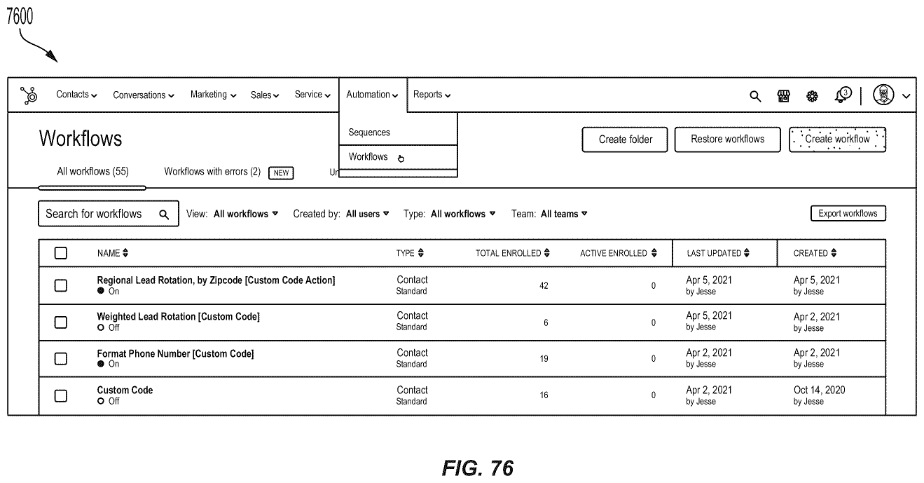

In example embodiments, FIGS. 76-79B show example screenshots of user interfaces (UIs) relating to the use of the custom workflow actions system 564 (e.g., custom code workflow actions tool) and related processes on the multi-service business platform 510. These figures are screenshots of example graphical user interfaces (GUIs) allowing a user to create one or more custom workflow actions and then execute these created custom workflow actions as part of one or more workflows.

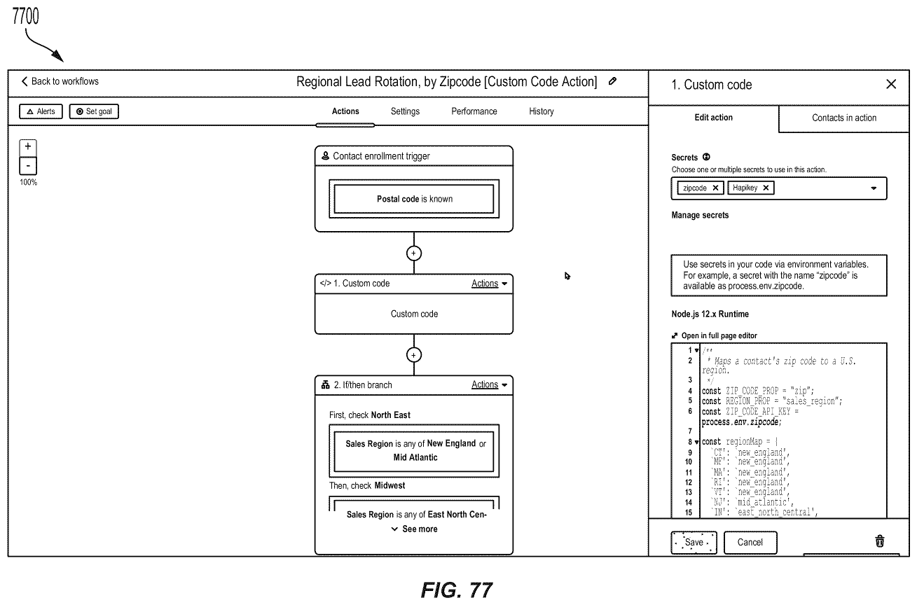

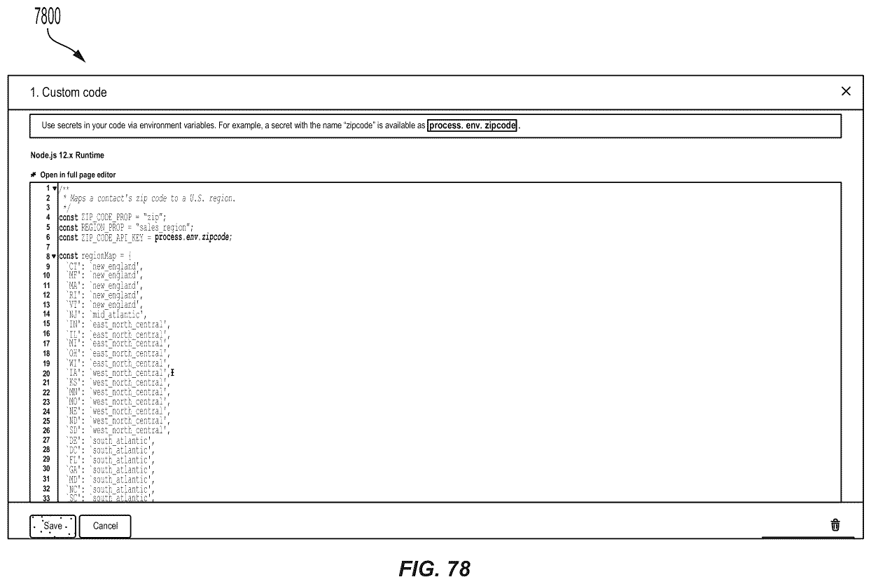

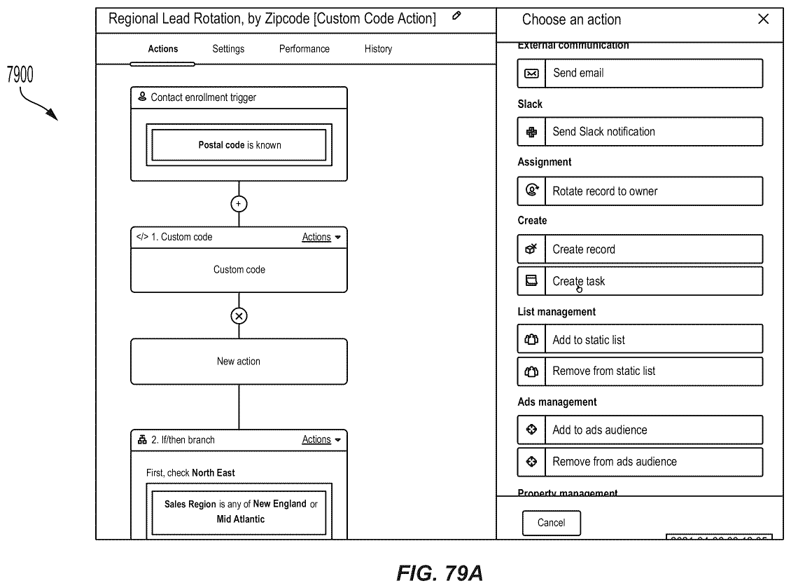

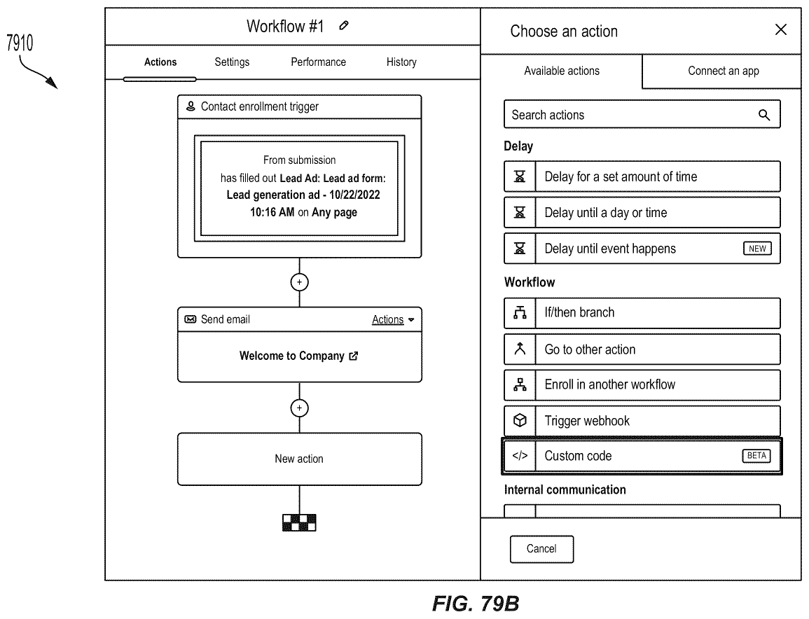

In example embodiments, FIG. 76 shows a screenshot of a graphical user interface (GUI) 7600 for displaying an example workflow tool (e.g., using workflow system 562). As shown in FIG. 76, this workflow tool may be found under workflows in automation (e.g., within a top navigation tool set). This may provide a home where a visual automation builder may be used. This may allow for processes such as triggers and actions to be executed. In example embodiments, FIG. 77 shows a screenshot of a graphical user interface (GUI) 7700 for displaying an example custom code action (e.g., using custom workflow actions system 564). In some examples, as shown in FIG. 77, this custom code action (e.g., effectively programmable automation) may provide a way for users to write and execute programming language (e.g., JavaScript) in an action. In example embodiments, the custom workflow actions system 564 may provide an interface (e.g., in the form of a relatively small instant virtual extranet (IVE)) that a user may use to create code (e.g., JavaScript) related to adding a function as shown in FIG. 78 (e.g., shows a screenshot of a graphical user interface (GUI) 7800 for displaying an example custom code action development interface). Then, when this added function executes, the multi-service business platform 510 may run this function. Custom code actions may extend workflow functionality within and external to the platform 510. In example embodiments, custom code actions may support JavaScript using a runtime framework such that when actions execute, a runtime compute may be managed through a serverless function (e.g., by the platform 510 and possibly other external services). In some examples, this may allow for the platform (e.g., multi-service business platform 510) to operate on all of the data that currently exists in the workflow. The data that currently exists in the workflow may enroll one or more objects when the workflow may be triggered. For example, the custom workflow actions process may either enroll a contact or a deal such that all of the data about that object (e.g., contact or deal) may be made available to be able to operate on. This may occur with any action in the workflow. In example embodiments, FIG. 79A shows a screenshot of a graphical user interface (GUI) 7900 for displaying an example “choose an action” interface (e.g., using custom workflow actions system 564) and FIG. 79B shows a screenshot of a graphical user interface (GUI) 7910 for displaying a selection of a custom code action from the “choose an action” interface (e.g., using custom workflow actions system 564). For example, related to FIG. 79B, a user navigated to “workflows” via “automation”, clicked on a “name” of a workflow or create a new workflow, clicked the “plus icon+” to add a workflow action, and then selected “custom code”. As shown in FIGS. 79A-79B, the custom workflow actions system 564 may allow the user to be able to perform various actions such as update CRM properties of an object, add the object to a list, or create a task associated with that object.

In example embodiments, the custom workflow actions process (including custom workflow actions system 564) may be combined with supporting features in workflows. For example, when a workflow may be triggered, the workflow may enroll an object. Typically, all of the data made available to a workflow may be the data about that object.

### Custom “Code” Workflow Actions

In example embodiments, the custom workflow actions system 564 allows for the creation of custom code actions for a workflow. For example, users may write and execute programming language (e.g., JavaScript) within a custom action in workflows. In the workflow system 562 (e.g., “Workflow Actions” panel) there may be a new action that may be referred to as a “custom code action”, “custom code workflow action”, and the like as shown in FIG. 79B and described in the disclosure. When clicking on or selecting this “custom code action” link, a code editor may be opened for the user to input software code instructions for a workflow (e.g., using Node.js®). This new custom code action may be triggered when an object reaches this stage of a workflow where the custom code action is initiated. In example embodiments, the custom code actions may utilize an “exports” main function (e.g., “exports.main ( )”) that may be called when a code snippet action may be executed. In example embodiments, the custom code actions may each have an event argument that may be an object that may have details for the workflow execution. Also, the custom code actions may each have a callback function (e.g., “callback ( )”) that may be used to pass data back to the workflow (e.g., the callback function may be called in the “exports” main function). In some example embodiments, there may be an event object in JSON such as an example payload that includes reference to a portal ID, custom action definition ID, type of CRM object that may be enrolled in workflow, and a unique ID for execution. In example embodiments, there may be several libraries available for use within code actions (e.g., Node.js libraries). The libraries may be loaded using a normal require function of the code (e.g., typically towards a top section of the code).

Using the custom code action may allow for various other use case examples (and related processes) that may be performed with objects. For example, the system may run different processes on objects, calculate different fields within that data, etc. Further, the custom workflow actions process (e.g., using the custom workflow actions system 564) may execute API calls out to other systems or into the internal API to get other data.

### Custom Workflow Actions-Secrets

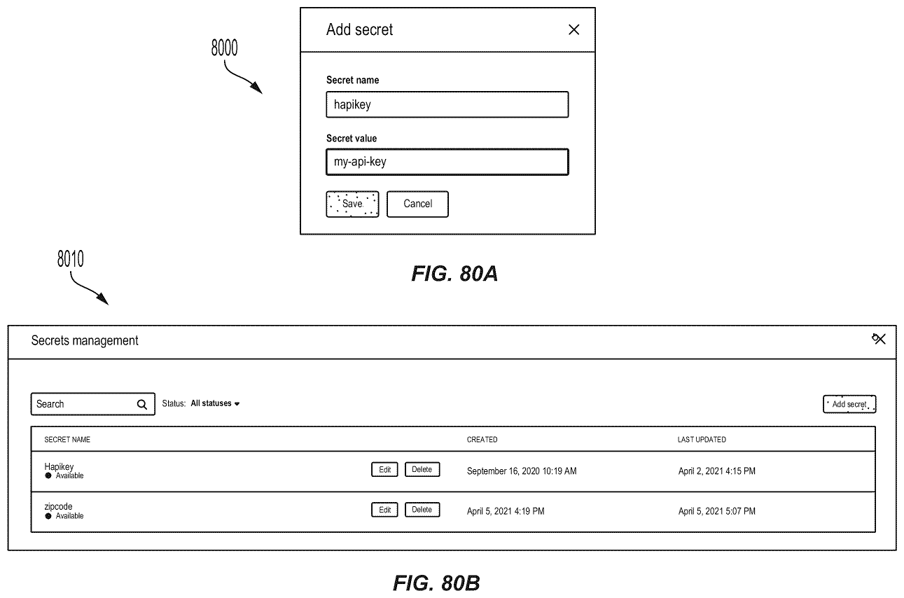

There may be example instances where the code may refer to something that may not be widely shared. For example, this may be a means of authentication (e.g., an API key). The custom workflow actions system 564 may allow for the management of secrets that a function may have access to directly in the workflow action definition. In example embodiments, FIG. 80A shows a screenshot of a graphical user interface (GUI) 8000 for displaying an example “add a secret” interface (e.g., using custom workflow actions system 564) and FIG. 80B shows a screenshot of a graphical user interface (GUI) 8010 for displaying an example secrets management interface (e.g., using custom workflow actions system 564). Any values needed may be added including a platform API key as shown in FIGS. 80A-80B (e.g., secret name: “hapikey” and secret value: “my-api-key”). Once added, the secrets may be available as environment variables.

As shown in FIGS. 80A-80B, the custom workflow actions system 564 may provide the ability for users to add API secrets that users may authenticate into various different services that they want to call out. Within the code itself, the user may make API calls (e.g., call the platform contact API and/or call the contact API in order to obtain information such as zip codes of contacts or other data). This data may be obtained to be acted on by the user within the platform. In other example embodiments, this may be accomplished with external services and external APIs. In general, the custom code action may open up a variety of possibilities and example use cases that the user may write and execute (e.g., using JavaScript). In example embodiments, to use a secret in with a custom code action, a “Secrets” dropdown menu may be clicked and then an “existing secret” may be selected or a “new secret” may be added. The “new secret” may be added by clicking on “add secret”, enter “Secret name” and “Secret value”, and then save such that this “new secret” may be selected in future custom code actions. Existing secrets may be edited or deleted via a “Manage secrets” interface.

### Custom Workflow Actions-Expansion of Available Data (Zip Code Example)

Example available data to workflows may be expanded. In one example, it may be expanded to include data passing. This may mean that any action that happens may also take the custom code action. In this example, the custom code action may view a contact, may pull in the zip code of the contact, and then may call out to the zip code API. The zip code API may allow for extraction of zip code data, calling up the API, and then may associate that data to different states and regions. With this information, the user may configure the workflow such that if a customer filled out that they are from a particular zip code, then that customer may be associated with a particular region which then may be passed off to a user (e.g., user's company's sales team). Other similar configurations may be performed using the custom code action. This may allow for extraction of the result of that data and then passing it through to the rest of the workflow. This may eliminate a need to make an API call back to the internal platform (e.g., multi-service business platform 510) to write it onto a CRM property. This process of data passing may provide an expansion of the amount of data that may be accessible to the workflow itself. When the workflow may be executing, the workflow may become more successful (e.g., improved quality) and more capable with every action that may happen and may expand the amount of data that may be available.

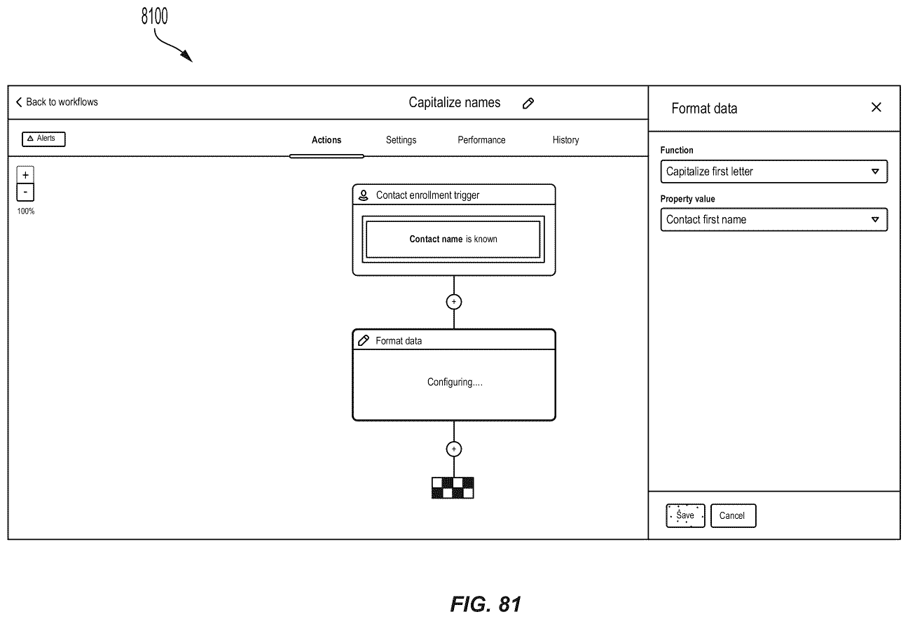

This zip code feature may be one example of how the custom workflow actions system 564 may be used. In this example, the custom workflow actions system 564 may be used to develop code to expand information (e.g., access zip code information) that may be available to workflows (e.g., used to segment customers by region based on zip codes). In other examples, the user may prefer to use the custom workflow actions system 564 to develop code to capitalize contact names (e.g., capitalize last names). In example embodiments, FIG. 81 shows a screenshot of a graphical user interface (GUI) 8100 for displaying an example “format data” interface (e.g., using custom workflow actions system 564). For example, FIG. 81 shows a workflow having a custom code action used in providing functionality of capitalizing names. Specifically, as described in the disclosure, the custom workflow actions system 564 may be used to create a code action for capitalizing contact names (e.g., capitalize last names) as shown in FIG. 81. The custom workflow actions system 564 may provide flexibility to users based on their general business needs and purposes.

In example embodiments, there may be a state that may be passed into one of these functions called an event. This may describe a variety of fields that are available to the workflow (e.g., in the platform). What comes in the event may be an origin or portal, some information about the action, the object that was enrolled (e.g., that may be looked), and a callback ID for this execution if logging it or the like is preferred.

### Example Code Process

In example embodiments, there may be a passing in of what objects are enrolled and/or what objects (e.g., contact objects) may be started in workflows which may be directed to the code of the custom workflow actions system 564 that the platform 510 may need for some next actions. From there, the platform 510 may search/query. Then at the end, the code may pass in the ability to pass out data. This may be called a callback where information or data may be passed. In some examples, this code may hit or execute an API from another service and may look up information and retrieve a phone number that may need to be found and pulled externally. This may enrich the contact data which may be passed out of the workflow by transferring the data to predefined fields (e.g., email and phone which may be defined). In example embodiments, FIG. 82 shows a screenshot of a graphical user interface (GUI) 8200 for displaying an example custom code action (e.g., using custom workflow actions system 564) related to formatting a phone number. Then, as shown in FIG. 82, the code may specify what kind of data may be expected to output this custom code action. The reason for specifying this output may be so that the downstream actions may know and anticipate what to expect (e.g., copy property action which may be copying the value of the phone number from the custom code action to a custom property boom as shown in FIG. 83). In example embodiments, FIG. 83 shows a screenshot of a graphical user interface (GUI) 8300 for displaying an example copy property value interface (e.g., using custom workflow actions system 564). In example embodiments, this may allow for outputs (e.g., outputs passed from the workflow) to be used in subsequent actions in the workflow such that the output data may be passed to subsequent actions within the workflow and/or other workflows.

In example embodiments, workflows may be a flow diagram that relate to some change that occurred within the platform 510 providing a series of steps that may occur as a result of that change. The workflow may span seconds or days, in terms of how long it may take to execute. Accordingly, in some examples, starting the workflow may occur from a form submission from a contact, and then multiple days later the user may be working on a drip email campaign for customers. This may be all based around conditional actions that may occur where if a customer of the user filled out the form and then viewed the landing page after the email was sent, it may trigger some action. The custom workflow actions system 564 (and related processes) may allow for users to customize what they may want to act on based on an event occurring. This may allow users or developers to take control over the value they may get out of the use of the platform 510 by providing their own custom code. The custom workflow actions system 564 (and related processes) may give users autonomy and control to build particular workflows for their business use cases and needs. This may allow users to solve problems (using the custom workflow actions system 564) within the overall platform (e.g., multi-service business platform 510) without having to use another third-party tool or service due to the integration of the custom workflow actions system 564 and related custom workflow actions processes in the platform 510. The user may add any number of desired actions with custom code at any number of steps in a workflow that may be dependent upon particular challenges the user may be trying to solve by using the workflows tool (e.g., using the custom workflow actions system 564). For example, there may be a workflow that has four actions that may have a custom code for one of the four actions or there may be a workflow that may have one action that may be a custom code action. The custom workflow actions system 564 and custom workflow actions processes may allow for running this code internally with respect to the platform 510 (e.g., use service where the code may be running). This may allow any user from any company size (large, medium, or small company) to write this type of code which may be immediately run by the integrated platform.

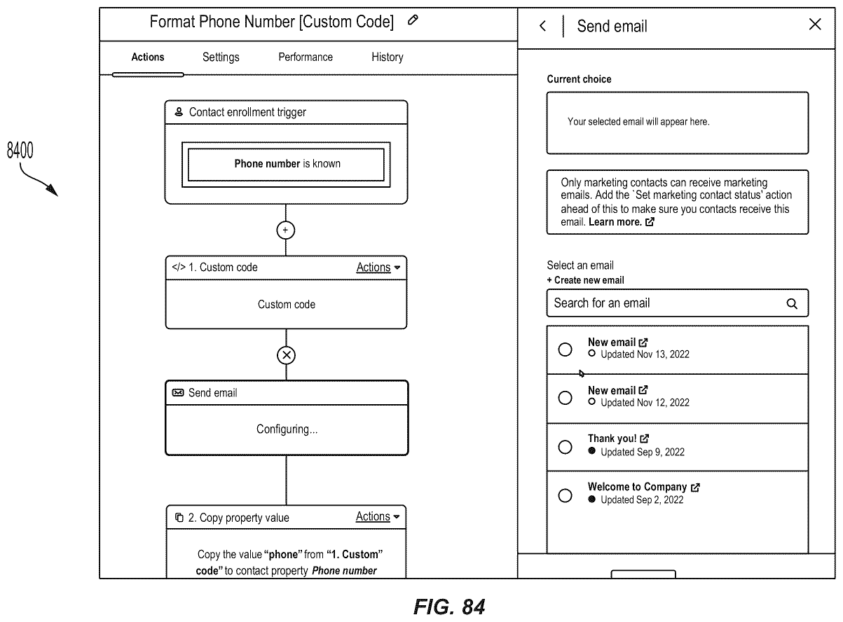

In general, each custom code action may be an action within a larger workflow. The custom code action may fit into a broader category of actions. There may be pre-packaged actions, as shown in FIGS. 79A-79B and 84, that may have already been created (e.g., “send email” action as shown in FIG. 84). FIG. 84 shows a screenshot of a graphical user interface (GUI) 8400 for displaying an example “send email” interface (e.g., using custom workflow actions system 564) which may be built into workflows (e.g., may have a UI that may be already built-in). This “send email” action may allow for a selection of emails to be sent such that when this action executes, contacts may be sent a particularly selected email. There may be other prepackaged actions that provide external communication by sending an email or sending a notification (e.g., Slack notification), provide assignment (e.g., rotate a record to the owner), provide creation (e.g., create a record or create a task), provide list management (e.g., add to a static list or remove from a static list), provide ads/advertisement management (e.g., add to an ads audience, remove from an ads audience, or the like), provide delay (e.g., delay for a set amount of time, delay until a day or a selected time, delay until an event happens, or the like), provide internal communication (e.g., send internal email notification, send internal marketing email, send internal short message service (SMS), send in-app notification, or the like), etc. Most relevant one of the actions may be providing a workflow which may be selected as either an if/then branch, a go to other action, enroll in another workflow, trigger webhook, a custom code, or the like. All of the steps or separate instructions in the custom code are together part of a custom code action. This may allow the user to build/customize actions (e.g., custom code actions) as needed based on the user's business needs.

The custom code actions may be connected with other actions as shown in the workflow (e.g., flow chart diagram) of FIGS. 77, 79A, 82, 83, and 84. An action may be any one of the steps in the flow chart diagram of these workflows (e.g., actions may be executed as part of the workflow). In some examples, an action may be a “delay” action. The delay action may wait or delay for a specified period of time (e.g., one day). In some examples, a custom code action may be written to do a similar delay along with other steps to form a new custom code action that may include delay as one step in the custom code action. In another example, there may be a “Set Properties” action where the workflow system 562 may output the property that was enrolled and then request setting the specific property to a specific value which may then be set. This may be hard coded into the automation tool which may have been created with the user interface (UI) for this platform. In example embodiments, this action may be created with a custom code action by looking up or identifying the contact that was passed to the user and then the system may use APIs to set a property to a desired value by the user. In example embodiments, the custom code action may be a type of extension which may be any action that is not hard coded into the platform. These custom actions may be written using an extension interface (e.g., of the custom workflow actions system 564) as described in the disclosure. The custom code actions may be specific to each portal and each workflow for the user. The code that the user writes for the custom code action may be unique or specific to that workflow. Specific tasks or steps in the custom code (e.g., defined within the custom code action) may be used elsewhere but the combination of the custom code action in one workflow (with other actions in the workflow or by itself as a sole action in the workflow) may be unique to only that workflow.

In example embodiments, the custom code action may be used to solve problems for the users. The custom code action may be used in some circumstances to create similar or the same predefined types of actions that may be hardcoded into the platform. In some examples, the users may use the platform marketplace to install an integration that may provide additional functionality inside of the automation tool. Converting some custom code actions to hard coded actions may occur where it may become apparent that the process (e.g., instruction steps of the process) of the custom code action may provide solutions to some problems for the majority of users. There may be a balance between use of custom code action (e.g., purpose built through code) versus default code within the platform.

In example embodiments, some custom code actions may be formula actions. These custom code actions may be used in a variety of use cases such as capitalizing names and the like. In some examples, the custom workflow actions system 564 may provide a list of formula actions that may be selected and then executed. These formula actions may also be built using custom code that may be specific to each user's interests.

### Example Custom Code Action Template

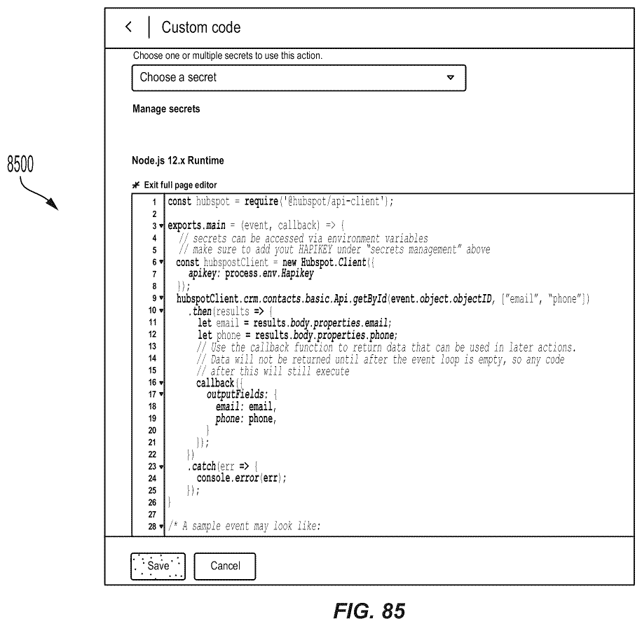

In example embodiments, FIG. 85 shows an example screenshot of a graphical user interface (GUI) 8500 for displaying an example custom code action template (e.g., using custom workflow actions system 564). Creation of a new custom code action may be performed by writing code that may be added as an action within a workflow. For example, the custom code (defined within the custom code action) may be written in JavaScript. The custom code (e.g., JavaScript code) may be run within a serverless container (e.g., AWS Lambda service or similar services). This may allow for the custom code to be run by the platform 510 (e.g., using the platform infrastructure). In the example custom code action, as shown in FIG. 85, the platform 510 may be initially defined such that a library may be imported (e.g., importing a platform API client) so that API calls may be made from the platform. Next, the custom code action may open a scope such that code in two curly brackets may be inside a main function. The event and callback may be passed into this scope for use. For example, this event may be available, which may be the information that may be shown in the comment (e.g., towards the bottom of code) that this event may occur. Then, the callback may be a type of handle that may allow for passing of data. In this example, there may be a few comments that discuss secrets. Then, the custom code action request may ask to obtain an object from an API. The API request may be signed with an API key or other authentication mechanism to identify the user. Then, the code may extract an identification (ID) from the object data returned by the API and use it in subsequent actions or requests. In some examples, the custom code action may include requests for lookup of contacts at the CRM and then may use an API to obtain by ID. This may include a request to take some action. Then, the action that is being initiated or executed may be using the information that was passed on by the event to get the ID of the contact that has been enrolled in this workflow. For example, the platform 510 may be used to obtain a contact by this event along with the related email and phone. In some examples, this custom code may limit the information request of contacts to emails and phone numbers only.

### Other Custom Code Action Examples

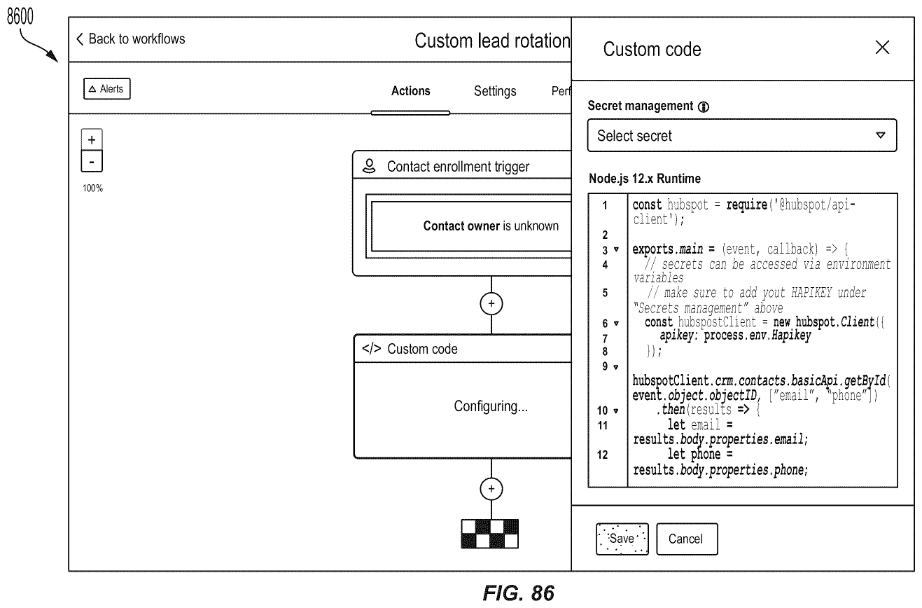

In example embodiments, FIG. 86 shows an example screenshot of a graphical user interface (GUI) 8600 for displaying another similar example of a custom code action (e.g., using custom workflow actions system 564). When this custom code action completes or finishes, the custom workflow actions system 564 may indicate a location of the results. This example may provide an ability to access related data in the custom code (e.g., JavaScript code) but the data itself may be returned in a data-interchange format for storing and exchanging data (e.g., JavaScript Object Notation (JSON)) as shown in FIG. 86. Then, a callback may allow for the user to specify outputs for this custom code action. In some examples, this may be simply looking up emails and phone numbers from the CRM and then passing them back out because this information was not available. In other examples, the custom code may allow the user to define the output of the custom code action as being a specific number of strings (e.g., two strings) where a string may be a series of characters, an email address, a phone number, and/or the like. This data may be used in later parts of the workflow such that the overall action may be a straight look up action. Then, there may be some error handling at the end of the code.

As described in the disclosure, there may be associations defined between objects in the platform 510. For example, a contact object may be associated with deal objects such that the same contact objects may be associated with company objects. When a contact gets enrolled in the workflow, the user may look up anything that may be available through this API. In some examples, the platform 510 may be used (e.g., using a platform client object in the JavaScript of the platform 510) to look up any associated objects. For example, users may want to add a dash to the beginning of the name of every deal that may be associated with a particular contact. In example embodiments, this may be coded into the custom code action such that the contact may be enrolled, the API may be used to look up all of the associated deals, the deal objects may be obtained, the name of these objects may be obtained, dashes may be added next to the names, all names may be set, and then the process may end.

In other examples, a “Get by ID” function may be searched and pulled by the custom workflow actions system 564. The custom workflow actions system 564 may not have to use the event object ID. For example, if preferred, a contact may be associated with an ID number (e.g., ID #12). This number may be used to search or look up arbitrary information from the platform 510 (e.g., obtaining object information associated with ID #12).

In example embodiments, in relation to data passing, there may be an application that may define the output of the action. The other part may be data passing such that this may be the data that may be defined by this action such that another action may pull it. Working on the inputs may be accomplished such that the inverse of this for a custom code action may pass data into the action. For example, one custom code action or another action may define that output and pass it into the action.

In other example embodiments, there may be data fetching. For example, this data may be available in the workflow such that the custom workflow actions system 564 may consider contact objects as enrolled such that associated data, or the data of other objects created, may be accessed. In another example, if the user prefers to obtain data that may not be related to the enrolled object or the other data that is created, there may be some ability to fetch data from either elsewhere on the platform 510, from an extension, from a connection to another system, etc. Being able to fetch data from the platform 510 (e.g., at least data associated with the platform 510) may be another example embodiment which may avoid the need to make API calls. This becomes valuable for two main reasons. One reason may be that a function may be limited in its size such that more API calls made may be taking away from what may be written. Second, every API call may count against the user's API call limits such that the fewer API calls required to be transmitted to the platform because of exposing the data in different ways, the more the user may actually utilize the data. This may allow the user to develop or write all of these API calls in the code. In some examples, all of the data within the platform 510 may be made available as a point-and-click type of relationship such that the user may not have to make these API calls.

Other custom code action examples may include: data cleanup/formatting (e.g., reformatting phone numbers, dates, text/names, etc.), advanced lead rotation (e.g., doing a weighted rotation based on seniority and also splitting them up based on geographies), service level agreement (SLA) management such that issues and deals may be easily kept on track, using data from an external service to verify customer inputs (e.g., real estate example), advanced customer onboarding automation, and the like. In general, there may be two main buckets (e.g., buckets of information) for the custom code action. One bucket may be to keep user data clean. This bucket example may refer to reformatting phone numbers, reformatting dates, or reformatting other data in the CRM or anywhere else to be used in an improved way. The other type of bucket may be to drive processes (e.g., bespoke processes). For example, there may be a sales process where leads may be rotated through teams different than the way that other teams do it because it may be based on seniority of representatives (reps), region of reps, and other factors. These factors may be used to drive different processes. Some of these processes may be advanced leave rotation, SLA management (e.g., related to items such as tickets and deals), and the like. In example embodiments, the custom workflow actions system 564 may be useful to users in various markets (e.g., real estate services). In real estate, the custom workflow actions system 564 may be used by the user to create a custom code action to call a third-party real estate service API (e.g., Zillow API) which may be used to pull in listing data. This may be used either to pull in data to the platform for analysis and/or to provide verification that inputted data is accurate. In general, the custom workflow actions system 564 may be used with these two buckets of either keeping data clean in the CRM and/or running bespoke business processes to help customize how automation may help a business.

### Weighted Lead Rotation Example

In example embodiments, as described in the disclosure, custom code actions may be used with weighted lead rotations. This may allow users to evenly distribute new contacts to a rep center team or decide a weighted percentage of distribution of contacts amongst a team (e.g., based on preferred weighting). The team may be viewed as owners (e.g., each owner may have a different ID) to these contacts within the workflow system 562. In an example workflow, there may be an initial action where if a contact owner is known, the contact may be enrolled in the workflow. Within an example custom code action (e.g., using the custom workflow actions system 564), the owner IDs may be assigned as part of a function. Each owner ID may be associated with different weighting (e.g., percentage weighting) which may be revised or changed based on a user's preference. There may be no limit to the number of owners (e.g., owner IDs) included in this process. When the custom code action executes, the contacts may be evenly distributed based on the selected weighting of each owner. In this example workflow, there may be a “simple branch” action that may occur after the custom code action. The “simple branch” action may branch out an output of the custom code action to the different owners (e.g., different owner IDs). The properties may be set for each owner (e.g., each owner ID). This may provide flexibility for users in setting up their weighted lead rotation process.

### Data Cleanup/Formatting Example (E.g., Phone Numbers)

In example embodiments, as described in the disclosure, custom code actions may be used with keeping data clean through formatting (e.g., formatting phone numbers). For example, CRM data may be received in a non-usable format (e.g., “1234567890”). In an example workflow, a first action may enroll all contacts when a phone number is known. In this workflow, a custom code action may be created that may go through each of these contacts, find the phone number, and then may reformat the phone number to a form that may be useable for team members (e.g., sales reps) that may use these phone numbers (e.g., to make calls to contacts). For example, when executing this custom code action, the phone number “1234567890” may be formatted to “(123) 456-7890” which may be more readable and useable for team members (e.g., sales reps).

### Bidirectional Data Sync

In example embodiments, there may be a bidirectional data sync that may be built (e.g., using PieSync™ technology). Workflows may use this technology generally. For example, it may be possible to trigger workflows as a result of a sync update. It may not be relevant to the workflow because data or information may have changed such that the sync may be another way to change the workflow. Syncing may allow for accessing a set of applications that users may get value out of by pulling data into the platform 510 because of custom objects, custom events, etc. This may add additional power and automation into all these custom data sets and also the platform 510 to find data sets. This may provide true automation of business processes on top of the platform 510 in a unified way. With the custom workflow actions system 564, users may solve business process problems and automation problems using this tool that stores business data sets. The custom workflow actions system 564 may be built into and integrated with the platform 510. There are many benefits to having all this functionality in one place versus needing to jump or switch between different applications and go through the administrative overhead or operational overhead of working with third party tools.

### Format Data Action

The format data action may be implemented in a custom code action that may allow for use with a variety of use cases. For example, the custom code action may include written code (e.g., JavaScript code) to reformat a name, a date, or other data. The custom workflow actions system 564 may have the flexibility to allow users to reformat data in a preferred way by the user (e.g., although not required, users may have flexibility through the use of JavaScript). In some examples, markup language (e.g., filtering markup language such as HubL) may be used. These filters may allow users to take a filter, apply the filter to data or portions of data, may allow users to reformat data in any way, etc. These filters may also be used with a templating language.

Examples of Automation, Unified Events, and Conversation Intelligence with Workflows

In example embodiments, workflows may be integrated with contextual automation. In other examples, event-driven automation may be built into delays. There may be a lot of other interesting topics such as how this technology may uniquely solve some of the challenges for users that may be hard to do with other tools as described in the disclosure.

In example embodiments, the platform 510 may have a unified event system (e.g., using event system 522) such that users may be able to define their own events. This may facilitate triggering specific actions. In other examples, there may be behavioral events for marketing events. It may determine how a user may be interacting with a customer indicating who may be interacting with the user's business such that some events may be triggering as a result of that interaction. There may be some interesting values to having this interaction directly connected to the CRM. It may provide added power to the entire platform 510 to allow for this behavioral interaction to be integrated with unified events by having all these data sets interacting with each other.

In example embodiments, the custom workflow actions system 564 and related processes may be used with the conversation intelligence system 528. For example, the call recording feature (e.g., of the conversation intelligence system 528) may provide speech analysis of recordings and may mark elements in these recordings based on keywords. These keywords may be events that may then trigger workflows. For example, if a speaker says a keyword such as “deals” on the call, it may trigger a workflow that then may perform an action (e.g., arbitrary action such as send a specific email to the customer). This workflow may be defined with one or more custom code actions by using the custom workflow actions system 564. In another example, the customer on a call may mention a competitor company during the call such that an email may be triggered as part of a workflow to follow up with competitive analysis to the customer. This may relate to unified events such that every event created within the platform may be plugged into custom workflow actions (e.g., custom code actions) that may be tied into data, systems, services, etc. in the platform 510. Then, the custom code action may be run with respect to this integration and/or actions (e.g., custom code actions) that may be discovered in the platform 510.

### Custom Workflow Integration

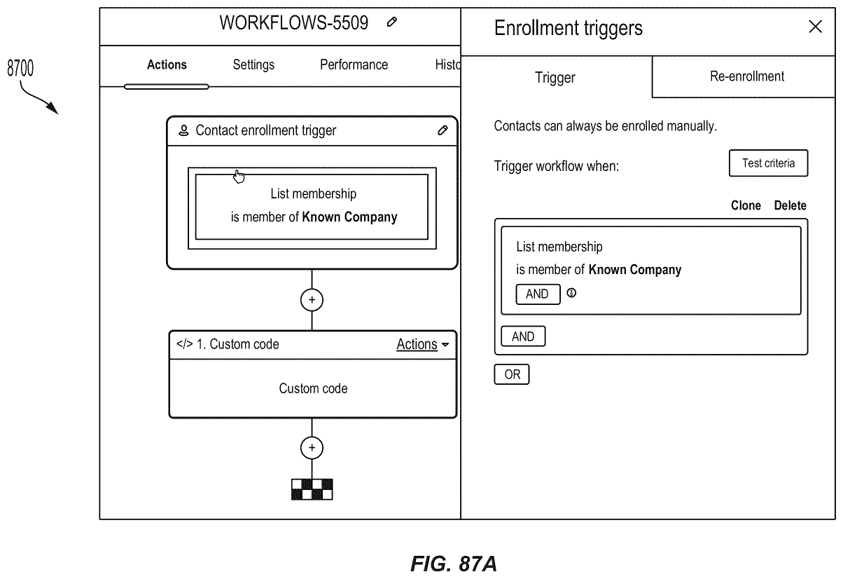

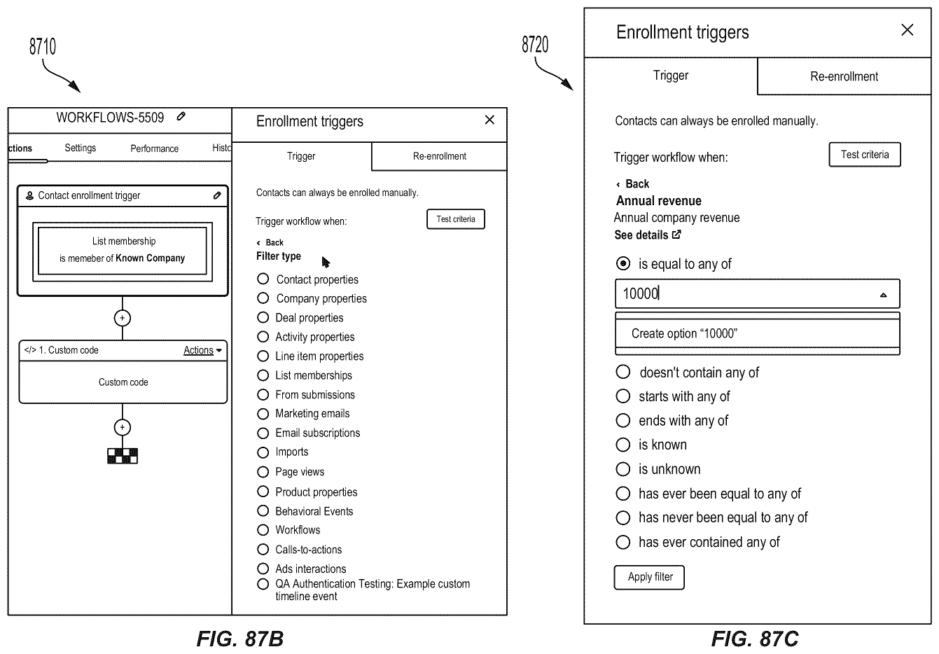

In example embodiments, FIGS. 87A-87C show example screenshots of graphical user interfaces (GUIs) 8700, 8710, 8720 for displaying enrollment trigger interfaces (e.g., using custom workflow actions system 564). Integration of workflows (e.g., specifically the custom workflows) may be accomplished through enrollment of workflows as shown in FIGS. 87A-87C. For example, enrollment may be how an object (e.g., contact or dealer company) may be enrolled in a workflow. If objects match a set of filters similar to how lists may be created on the platform 510 (e.g., creating a list of all customers whose annual revenue is over an amount such as $100,000), this may be used to enroll objects in workflows. For example, with events that may be currently in function, if an element (e.g., object) may match this list and an event occurs (e.g., if an event occurs to a particular contact), then the platform 510 may enroll the element (e.g., contact) in the workflow. This may relate to how workflows may be initiated. Then, there may be interactions with objects (e.g., contact objects) in the workflows that may be based on the custom code actions in the workflow. This may be referred to as enrollment criteria as shown in FIG. 87A. The enrollment criteria may define why an object may enter a workflow (e.g., a member of another list). This may be used in filtering such as based on contact properties (e.g., annual revenue of contact) as shown in FIGS. 87B and 87C. Accordingly, the filtering may be used as events that may be added and as conditions that may be added.

The background description is presented simply for context, and is not necessarily well-understood, routine, or conventional. Further, the background description is not an admission of what does or does not qualify as prior art. In fact, some or all of the background description may be work attributable to the named inventors that is otherwise unknown in the art.

Physical (such as spatial and/or electrical) and functional relationships between elements (for example, between modules, circuit elements, semiconductor layers, etc.) are described using various terms. Unless explicitly described as being “direct,” when a relationship between first and second elements is described, that relationship encompasses both (i) a direct relationship where no other intervening elements are present between the first and second elements and (ii) an indirect relationship where one or more intervening elements are present between the first and second elements. Example relationship terms include “adjoining,” “transmitting,” “receiving,” “connected,” “engaged,” “coupled,” “adjacent,” “next to,” “on top of,” “above,” “below,” “abutting,” and “disposed.” The detailed description includes specific examples for illustration only, and not to limit the disclosure or its applicability. The examples are not intended to be an exhaustive list, but instead simply demonstrate possession by the inventors of the full scope of the currently presented and envisioned future claims. Variations, combinations, and equivalents of the examples are within the scope of the disclosure. No language in the specification should be construed as indicating that any non-claimed element is essential or critical to the practice of the disclosure. The term “exemplary” simply means “example” and does not indicate a best or preferred example. The term “set” does not necessarily exclude the empty set—in other words, in some circumstances a “set” may have zero elements. The term “non-empty set” may be used to indicate exclusion of the empty set—that is, a non-empty set must have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements. The phrase “at least one of A, B, and C” should be construed to mean a logical (A OR B OR C), using a non-exclusive logical OR, and should not be construed to mean “at least one of A, at least one of B, and at least one of C.” The use of the terms “a,” “an,” “the,” and similar referents in the context of describing the disclosure and claims encompasses both the singular and the plural, unless contradicted explicitly or by context. Unless otherwise specified, the terms “comprising,” “having,” “with,” “including,” and “containing,” and their variants, are open-ended terms, meaning “including, but not limited to.” Each publication referenced in this disclosure, including foreign and domestic patent applications and patents, is hereby incorporated by reference in its entirety. Although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of multiple embodiments remain within the scope of this disclosure. One or more elements (for example, steps within a method, instructions, actions, or operations) may be executed in a different order (and/or concurrently) without altering the principles of the present disclosure. Unless technically infeasible, elements described as being in series may be implemented partially or fully in parallel. Similarly, unless technically infeasible, elements described as being in parallel may be implemented partially or fully in series. While the disclosure describes structures corresponding to claimed elements, those elements do not necessarily invoke a means plus function interpretation unless they explicitly use the signifier “means for.” While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. In the drawings, reference numbers may be reused to identify identical elements or may simply identify elements that implement similar functionality. Numbering or other labeling of instructions or method steps is done for convenient reference, not to indicate a fixed order.

In the drawings, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. As just one example, for information sent from element A to element B, element B may send requests and/or acknowledgments to element A.

Unless otherwise indicated, recitations of ranges of values are merely intended to serve as a shorthand way of referring individually to each separate value falling within the range, and each separate value is hereby incorporated into the specification as if it were individually recited.

A special-purpose system includes hardware and/or software and may be described in terms of an apparatus, a method, or a computer-readable medium. In various embodiments, functionality may be apportioned differently between software and hardware. For example, some functionality may be implemented by hardware in one embodiment and by software in another embodiment. Further, software may be encoded by hardware structures, and hardware may be defined by software, such as in software-defined networking or software-defined radio. In this application, including the claims, the term module refers to a special-purpose system. The module may be implemented by one or more special-purpose systems. The one or more special-purpose systems may also implement some or all of the other modules. In this application, including the claims, the term module may be replaced with the terms controller or circuit. In this application, including the claims, the term platform refers to one or more modules that offer a set of functions. In this application, including the claims, the term system may be used interchangeably with module or with the term special-purpose system. The special-purpose system may be directed or controlled by an operator. The special-purpose system may be hosted by one or more of assets owned by the operator, assets leased by the operator, and third-party assets. The assets may be referred to as a private, community, or hybrid cloud computing network or cloud computing environment.

For example, the special-purpose system may be partially or fully hosted by a third party offering software as a service (SaaS), platform as a service (PaaS), and/or infrastructure as a service (IaaS). The special-purpose system may be implemented using agile development and operations (DevOps) principles. In embodiments, some or all of the special-purpose system may be implemented in a multiple-environment architecture. For example, the multiple environments may include one or more production environments, one or more integration environments, one or more development environments, etc.

A special-purpose system may be partially or fully implemented using or by a mobile device. Examples of mobile devices include navigation devices, cell phones, smart phones, mobile phones, mobile personal digital assistants, palmtops, netbooks, pagers, electronic book readers, tablets, music players, etc. A special-purpose system may be partially or fully implemented using or by a network device. Examples of network devices include switches, routers, firewalls, gateways, hubs, base stations, access points, repeaters, head-ends, user equipment, cell sites, antennas, towers, etc. A special-purpose system may be partially or fully implemented using a computer having a variety of form factors and other characteristics. For example, the computer may be characterized as a personal computer, as a server, etc. The computer may be portable, as in the case of a laptop, netbook, etc. The computer may or may not have any output device, such as a monitor, line printer, liquid crystal display (LCD), light emitting diodes (LEDs), etc. The computer may or may not have any input device, such as a keyboard, mouse, touchpad, trackpad, computer vision system, barcode scanner, button array, etc. The computer may run a general-purpose operating system, such as the WINDOWS operating system from Microsoft Corporation, the MACOS operating system from Apple, Inc., or a variant of the LINUX operating system. Examples of servers include a file server, print server, domain server, internet server, intranet server, cloud server, infrastructure-as-a-service server, platform-as-a-service server, web server, secondary server, host server, distributed server, failover server, and backup server.

The term hardware encompasses components such as processing hardware, storage hardware, networking hardware, and other general-purpose and special-purpose components. Note that these are not mutually-exclusive categories. For example, processing hardware may integrate storage hardware and vice versa. Examples of a component are integrated circuits (ICs), application specific integrated circuit (ASICs), digital circuit elements, analog circuit elements, combinational logic circuits, gate arrays such as field programmable gate arrays (FPGAs), digital signal processors (DSPs), complex programmable logic devices (CPLDs), etc. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an artificial intelligence (AI) system-on-chip, a video processing system-on-chip, an organ-on-chip, a quantum algorithm system-on-chip, etc. The hardware may integrate and/or receive signals from sensors. The sensors may allow observation and measurement of conditions including temperature, pressure, wear, light, humidity, deformation, expansion, contraction, deflection, bending, stress, strain, load-bearing, shrinkage, power, energy, mass, location, temperature, humidity, pressure, viscosity, liquid flow, chemical/gas presence, sound, and air quality. A sensor may include image and/or video capture in visible and/or non-visible (such as thermal) wavelengths, such as a charge-coupled device (CCD) or complementary metal-oxide semiconductor (CMOS).

Examples of processing hardware include a central processing unit (CPU), a graphics processing unit (GPU), an approximate computing processor, a quantum computing processor, a parallel computing processor, a neural network processor, a signal processor, a digital processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an artificial intelligence (AI) co-processor.

The processor may enable execution of multiple threads. These multiple threads may correspond to different programs. In various embodiments, a single program may be implemented as multiple threads by the programmer or may be decomposed into multiple threads by the processing hardware. The threads may be executed simultaneously to enhance the performance of the processor and to facilitate simultaneous operations of the application.

A processor may be implemented as a packaged semiconductor die. The die includes one or more processing cores and may include additional functional blocks, such as cache. In various embodiments, the processor may be implemented by multiple dies, which may be combined in a single package or packaged separately.

The networking hardware may include one or more interface circuits. In some examples, the interface circuit(s) may implement wired or wireless interfaces that connect, directly or indirectly, to one or more networks. Examples of networks include a cellular network, a local area network (LAN), a wireless personal area network (WPAN), a metropolitan area network (MAN), and/or a wide area network (WAN). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching and virtual private networks.

Storage hardware is or includes a computer-readable medium. The term computer-readable medium, as used in this disclosure, encompasses both nonvolatile storage and volatile storage, such as dynamic random access memory (DRAM). The term computer-readable medium only excludes transitory electrical or electromagnetic signals propagating through a medium (such as on a carrier wave). A computer-readable medium in this disclosure is therefore non-transitory, and may also be considered to be tangible.

Software includes instructions that are machine-readable and/or executable. Instructions may be logically grouped into programs, codes, methods, steps, actions, routines, functions, libraries, objects, classes, etc. Software may be stored by storage hardware or encoded in other hardware. Software encompasses (i) descriptive text to be parsed, such as HTML (hypertext markup language), XML (extensible markup language), and JSON (JavaScript Object Notation), (ii) assembly code, (iii) object code generated from source code by a compiler, (iv) source code for execution by an interpreter, (v) bytecode, (vi) source code for compilation and execution by a just-in-time compiler, etc. As examples only, source code may be written using syntax from languages including C, C++, JavaScript, Java, Python, R, etc. Software also includes data. However, data and instructions are not mutually-exclusive categories. In various embodiments, the instructions may be used as data in one or more operations. As another example, instructions may be derived from data. The functional blocks and flowchart elements in this disclosure serve as software specifications, which can be translated into software by the routine work of a skilled technician or programmer. Software may include and/or rely on firmware, processor microcode, an operating system (OS), a basic input/output system (BIOS), application programming interfaces (APIs), libraries such as dynamic-link libraries (DLLs), device drivers, hypervisors, user applications, background services, background applications, etc. Software includes native applications and web applications. For example, a web application may be served to a device through a browser using hypertext markup language 5th revision (HTML5). Software may include artificial intelligence systems, which may include machine learning or other computational intelligence. For example, artificial intelligence may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs. Examples of the models include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformer (GPT).

Training a machine-learning model may include supervised learning (for example, based on labeled input data), unsupervised learning, and reinforcement learning. In various embodiments, a machine-learning model may be pre-trained by their operator or by a third party. Problem domains include nearly any situation where structured data can be collected, and includes natural language processing (NLP), computer vision (CV), classification, image recognition, etc.

What is claimed is:

1. A computer-implemented method for creating and using a custom action, the method comprising:
creating a new workflow associated with one or more events;
selecting a custom code action from a list of actions;
creating a new custom code action that is added to the new workflow based on the selection;
receiving a custom instruction code for a customized action associated with the new custom code action;
executing the new workflow based on an occurrence of the one or more events; and
triggering the new custom code action as part of the execution of the new workflow;
wherein the triggering of the new custom code action executes the custom instruction code resulting in the occurrence of the customized action corresponding with the custom instruction code.

2. The method of claim 1, further comprising a workflow system for controlling, configuring, and executing the new workflow in a platform, wherein the workflow system utilizes an automation application programming interface (API) to provide at least one of a “Get” functionality, a “Post” functionality, a “Put” functionality, or a “Delete” functionality with respect to the new workflow.

3. The method of claim 1, further comprising defining the new custom code action with at least one input and a web address such that when the new custom code action is triggered, at least one request is sent to the web address with a payload.

4. The method of claim 1, further comprising defining the new custom code action with workflow-related information for the new workflow, a preferred request format for requests received, an action name, and at least one action input.

5. The method of claim 4, wherein the defined new custom code action includes at least one input option that defines at least one set of valid values for the at least one action input, and wherein the at least one input option is at least one of a static list or a webhook web address.

6. The method of claim 1, further comprising determining a success of the new custom code action being triggered by examining a status code returned that indicates at least one of: an action completed successfully, an action failed, or a temporary problem with service.

7. The method of claim 1, wherein the one or more events are defined as a change in a platform such that the platform provides one or more actions including at least one of configuring or setting properties, sending emails, sending notifications, or calling one or more web addresses based, at least partially, on the change in the platform.

8. The method of claim 1, wherein the new custom code action includes a function that when executed allows for a platform to operate on data that is associated with the new workflow.

9. The method of claim 8, wherein the data relates to enrollment of one or more objects, and wherein the one or more objects include at least one of a core object or a custom object such that object-related data is available for operation when the new workflow is executed.

10. The method of claim 1, wherein the new custom code action provides at least one of: a process for keeping user data organized by reformatting data or a process for driving other processes.

11. The method of claim 1, wherein the new custom code action provides at least one of: data cleanup, data formatting and reformatting, advanced lead rotation, service level agreement (SLA) management, verification of customer data inputs based on an external service, or advanced customer onboarding automation.

12. A computer-implemented method for creating and using a custom action, the method comprising:
opening a previously created workflow associated with one or more events;
selecting a custom code action from a list of actions;
creating a new custom code action that is added to the previously created workflow based on the selection;
receiving a custom instruction code for a customized action associated with the new custom code action;
executing the previously created workflow based on an occurrence of the one or more events; and
triggering the new custom code action as part of the execution of the previously created workflow;
wherein the triggering of the new custom code action executes the custom instruction code resulting in the occurrence of the customized action corresponding with the custom instruction code.

13. The method of claim 12, further comprising a workflow system for controlling, configuring, and executing the previously created workflow in a platform, wherein the workflow system utilizes an automation application programming interface (API) to provide at least one of a “Get” functionality, a “Post” functionality, a “Put” functionality, or a “Delete” functionality with respect to the previously created workflow.

14. The method of claim 12, further comprising defining the new custom code action with workflow-related information for the previously created workflow, a preferred request format for requests received, an action name, and at least one action input.

15. The method of claim 12, further comprising determining a success of the new custom code action being triggered by examining a status code returned that indicates at least one of: an action completed successfully, an action failed, or a temporary problem with service.

16. The method of claim 12, wherein the one or more events are defined as a change in a platform such that the platform provides one or more actions including at least one of configuring or setting properties, sending emails, sending notifications, or calling one or more web addresses based, at least partially, on the change in the platform.

17. The method of claim 12, wherein the new custom code action includes a function that when executed allows for a platform to operate on data that is associated with the previously created workflow.

18. The method of claim 17, wherein the data relates to enrollment of one or more objects, and wherein the one or more objects include at least one of a core object or a custom object such that object-related data is available for operation when the previously created workflow is executed.

19. The method of claim 12, wherein the new custom code action provides at least one of: a process for keeping user data organized by reformatting data, a process for driving other processes, a data cleanup process, data formatting and reformatting processes, an advanced lead rotation process, a service level agreement (SLA) management process, a verification process of customer data inputs based on an external service, or an advanced customer onboarding automation process.

20. A non-transitory computer readable storage medium having a plurality of instructions stored thereon which, when executed across one or more processors, causes at least a portion of the one or more processors to perform operations comprising:
creating a new workflow or opening a previously created workflow associated with one or more events;
selecting a custom code action from a list of actions;
creating a new custom code action that is added to the new workflow or the previously created workflow based on the selection;
receiving a custom instruction code for a customized action associated with the new custom code action;
executing the new workflow or the previously created workflow based on an occurrence of the one or more events; and
triggering the new custom code action as part of the execution of the new workflow or the previously created workflow;
wherein the triggering of the new custom code action executes the custom instruction code resulting in the occurrence of the customized action corresponding with the custom instruction code.
